(19) United States
(12) Patent Application Publication
(10) Pub. No.: US 2026/0201170 A1
(43) Pub. Date: Jul. 16, 2026

(54) PROCESS FOR PRODUCING LOW GLOSS COATING SURFACE BY RADIATION CURING

(71) Applicants: Covestro LLC, Pittsburgh, PA (US); Covestro (Netherlands) B.V., Geleen (NL)

(72) Inventors: Huimin Cao, Naperville, IL (US); Johan Franz Gradus Antonius Jansen, Geleen (NL); Michael Christopher Villet, Maastricht (NL); Ilse van Casteren, Veldhoven (NL); Ronald Tennebroek, Dongen (NL); Erik-Jan van den Biggelaar, Raamsdonksveer (NL); Vincent van Dijk, Breda (NL); Ting-Hao Liu, Tiburg (NL)

(21) Appl. No.: 19/132,446

(22) PCT Filed: Dec. 12, 2023
(86) PCT No.: PCT/US2023/083475

§ 371 Date: May 23, 2025

Related U.S. Application Data
(60) Provisional application No. 63/432,824, filed on Dec. 15, 2022.
(60) Provisional application No. 63/432,827, filed on Dec. 15, 2022.
(60) Provisional application No. 63/432,835, filed on Dec. 15, 2022.
(60) Provisional application No. 63/432,842, filed on Dec. 15, 2022.

(51) Int. Cl. C09D 4/00; C09D 133/06; C09D 175/08

(52) U.S. Cl. CPC C09D 4/00; C09D 133/064; C09D 175/08

(57) ABSTRACT

The present invention relates to a method for producing a cured coating with a low gloss surface from an aqueous, radiation curable coating composition, wherein the method comprises the following steps:
(1) applying an aqueous, radiation curable coating composition on a substrate,
(2) drying the aqueous, radiation curable coating composition, affording an at least partially dried coating composition,
(3) irradiating the at least partially dried coating composition from step (2) with UV light having wavelengths essentially in the range from 231 to 280 nm, affording a coating with a partially cured surface layer with reduced gloss, followed by
(4) finish curing the coating from step (3) with actinic radiation, thereby fixating the partially cured surface layer with reduced gloss and affording the cured coating with the low gloss surface,
wherein step (3) and step (4) are performed in air; and
wherein the aqueous, radiation curable coating composition comprises at least one polymer, at least one reactive diluent, and water.

The present invention relates to a method for producing low gloss coating surface from aqueous coating compositions.

Aqueous coating compositions are widely used in the coating industry. However, usually upon drying of the aqueous coating composition glossy surfaces are obtained. “Low gloss” surfaces give products a much sought-after aesthetic effect, especially in the wood-furniture, flooring and wall covering industry, because they can create a very natural appearance that contribute to giving greater emphasis to the materiality of the article. At present, the creation of matte surfaces frequently involves the use of coating products the formulation of which contains matting agents made from organic and/or inorganic substances which, by positioning themselves on the coated surface and/or emerging on it, are able to act on the degree of reflection of light, giving the observer the visual sensation of a low gloss surface. However, the use of matting agents produces a worsening of the surface performance of the coating since they are not involved in the polymerization process. Further there is a tendency for the matting agent to migrate to the coating surface after application and consequently the matting agent might get lost upon mechanical deformation, caused by for example scratch, resulting in an increase of gloss.

The object of the present invention is to provide a method for obtaining a low gloss coating from an aqueous coating composition without having to use matting agents.

The object of the present invention is to provide a method for producing low gloss coating surface by radiation of an aqueous, radiation curable coating composition without having to use matting agents and without having to use an inert gas atmosphere in the radiation process.

According to the invention, there is provided a method for producing a cured coating with a low gloss surface from an aqueous, radiation curable coating composition, wherein the method comprises the following steps:
(1) applying an aqueous, radiation curable coating composition on a substrate,
(2) drying the aqueous, radiation curable coating composition, affording an at least partially dried coating composition,
(3) irradiating the at least partially dried coating composition from step (2) with UV light having wavelengths essentially in the range from 231 to 280 nm, affording a coating with a partially cured surface layer with reduced gloss, followed by
(4) finish curing the coating from step (3) with actinic radiation, thereby fixating the partially cured surface layer with reduced gloss and affording the cured coating with the low gloss surface,
wherein step (3) and (4) are performed in air; and
wherein the aqueous, radiation curable coating composition comprises at least one polymer, at least one reactive diluent, and water.

It has surprisingly been found that the process of the present invention allows to produce low gloss coating surface without having to use matting agents, and thus without negatively affecting the stain resistance of the coating. It has furthermore surprisingly been found that the curing can be performed in air and thus the method of the invention can be carried out without having to use an inert gas curing equipment in the UV radiation process. This is advantageous since inert gases, like nitrogen and argon are expensive, and, in addition, making an industrial curing line completely airtight is a challenge and thus losses of inert gas to the environment around the curing line may occur, making the process even more expensive and potentially impacting worker safety as this can lead to excessive inert gas concentration in the environment around the curing line.

For all upper and/or lower boundaries of any range given herein, the boundary value is included in the range given, unless specifically indicated otherwise. Thus, when saying from x to y, means including x and y and also all intermediate values.

The method of the present invention optionally includes an additional radiation curing step prior to step (3), i.e. prior to the step of irradiating with UV light essentially having wavelengths higher than 230 nm and lower than or equal to 280 nm. In this additional radiation curing step, the radiation curable coating composition from step (2) is pre-cured by irradiating with light with a radiation dose which results in partial curing of the coating composition from step (2) to a pre-gel or near gel point state. Accordingly, the method of the invention comprises the following steps:
(1) applying an aqueous, radiation curable coating composition on a substrate,
(2) drying the aqueous, radiation curable coating composition, affording an at least partially dried coating composition, (2a) optionally pre-curing the radiation curable coating composition from step (2) by irradiating with light, affording a partially cured coating,
(3) irradiating the at least partially dried coating composition from step (2) or the partially cured coating from step (2a), when present, with UV light having wavelengths essentially in the range from 231 to 280 nm, affording a coating with a partially cured surface layer with reduced gloss, followed by
(4) finish curing the coating from step (3) with actinic radiation, thereby fixating the partially cured surface layer with reduced gloss and affording the cured coating with the low gloss surface,
wherein step (3) and step (4) are performed in air.

In step (1) of the method of the invention, the aqueous, radiation curable coating composition is applied to a substrate by methods known to the person skilled in the art, such as for example knife coating, brushing, roller coating, spraying. The coating composition is applied to the substrate in a coating thickness of preferably from 5 to 300 micron, more preferably from 15 to 175 micron, more preferably from 20 to 150 micron, more preferably from 25 to 125 micron.

In step (2) of the process of the invention, drying of the aqueous, radiation-curable coating composition that is applied to the substrate is preferably effected at a temperature higher than 30° C. to evaporate water and optionally organic solvent and other volatile compounds, affording an at least partially dried coating composition. The term “drying” refers to the loss of water and, if present, organic solvent and other volatile compounds from the aqueous coating composition by evaporation to such extend that preferably at least 80 wt. % of the water is removed.

The skin cure step (3) of the method of the invention is performed by irradiating the at least partially dried coating composition from step (2) or the partially cured coating from step (2a) (when present) with UV light having wavelengths essentially in the range of from 231 to 280 nm, affording a coating with a partially cured surface layer with reduced gloss. The expression “UV light having wavelengths essentially in the wavelength range from X to Y (such as from 231 to 280 nm)” means that at least 60%, preferably at least 70% of the actinic radiation power of the applied radiation source is in the wavelength range of from X to Y (such as from 231 to 280 nm). As oxygen absorbs at wavelengths≤230 nm leading to the formation of ozone, it is in the present invention preferred that emissions at wavelengths≤230 nm are minimized (i.e. preferably at most 10%, more preferably at most 5%, even more preferably at most 2% and even more preferably at most 1% of the radiation power of the applied radiation source in step (3) emits light at wavelengths≤230 nm) or more preferred are even absent. Therefore preferably also of the radiation power of the applied radiation source that is emitted in the wavelength range from 200 to 390 nm, at least 60%, more preferably at least 70%, even more preferably at least 80% is in the wavelength range from X to Y (such as from 231 to 280 nm). More preferably also of the radiation power of the applied radiation source that is emitted in the wavelength range from 231 to 390 nm, at least 70%, more preferably at least 80%, even more preferably at least 90% is in the wavelength range from X to Y (such as from 231 to 280 nm).

The irradiating in step (3) is preferably carried out with UV light having wavelengths essentially in the range from 241 to 280 nm, more preferably in the range from 241 to 270 nm, even more preferably in the range from 244 to 265 nm, or preferably in the range from 251 to 280 nm, more preferably in the range from 251 to 260 nm.

The UV light applied in step (3) preferably has a UV radiation dose in the range from 2 to 200 mJ/cm², preferably has a radiation dose of at least 3 mJ/cm², or of at least 4 mJ/cm², or of at least 5 mJ/cm², and preferably has a radiation dose of at most 90 mJ/cm², preferably of at most 80 mJ/cm², or of at most 70 mJ/cm², or of at most 60 mJ/cm², or of at most 50 mJ/cm², or of at most 40 mJ/cm².

Suitable radiation sources for emitting light in a specified wavelength range can be selected by calculating the % of light emitted at the specified wavelength region from the spectral profile of the radiation source which can be obtained from the radiation source suppliers. The spectral irradiance can be expressed as irradiated power in W/nm or W/10 nm, or as spectral irradiance in W/m²/nm, or in relative scale. The spectral profile is a representation of how radiated output is distributed across the electromagnetic spectrum.

Suitable radiation sources for emitting UV light essentially in the specified wavelength range in step (3) of the method of the invention are for example low pressure mercury vapor lamps, or UVC LED lamps with peak wavelength in the range from 231 to 280 nm, for example with peak wavelength of 240 nm, or of 245 nm, or of 250 nm, or of 255 nm, or of 260 nm, or of 265 nm, or of 270 nm or of 275 nm, or Excimer lamps with peak wavelength in the range of from 231 to 280 nm, for example 248 nm (KrF*), or 253 nm (XeI*) or 259 nm (Cl₂*). For example, a suitable low pressure mercury vapor lamp that can be used in step (3) of the present invention is the BlueLight® Premium P2035 U V Disinfection Lamp System, obtainable from Heraeus Noblelight, having a dominant narrow emission peak at 254 nm with Full Width Half Maximum of 2 nm; it can be calculated from the spectral profile that in the wavelength range of from 200 to 390 nm, 91% of the irradiated power is emitted in the wavelength range of from 231 nm to 280 nm, more specifically from 251 to 260 nm.

Another suitable radiation source for emitting UV light in the specified wavelength range in step (3) is a medium pressure mercury vapor lamp used in combination with an optical bandpass filter with maximum transmission in the wavelength range of from 241 nm to 270 nm, preferably with an optical bandpass filter with maximum transmission in the wavelength range of from 251 to 260 nm, for example an optical bandpass filter with maximum transmission at 254 nm. A suitable bandpass filter is for example 254 nm, 10 nm FWHM, First Surface UV bandpass filter from Edmund Optics Ltd. Suitable medium pressure mercury vapor lamps to be used in combination with such an optical bandpass filter are for example Fusion H lamps and Fusion H+ lamps, obtainable from Heraeus Noblelight. By multiplying the spectral profile of the Fusion H Bulb or of the H+ Bulb provided by the lamp supplier by the % transmission spectrum of the band pass filter provided by the filter supplier, it can be calculated that 100% of the UV irradiated power is emitted in the wavelength range of from 231 nm to 280 nm when the Fusion H Bulb or H+ Bulb is used with this filter.

The skin cure step (3) is preferably performed with at most 6 lamps. Accordingly, the skin cure step (3) is preferably performed with 1 lamp, or with 2 lamps, or with 3 lamps, or with 4 lamps, or with 5 lamps, or with 6 lamps. Preferably each lamp has the width to cover entire width of the substrate, to form uniform gloss across entire surface. These lamps can be in one or multiple lamp units. Different lamp units can be set so that irradiance from individual lamp unit may vary, for example, earlier lamp unit(s) is (are) set at lower irradiance to form a fine multifold pattern, and later lamp unit(s) with further skin cure grows the magnitude higher to further lower the gloss. The skilled man appreciates that when using multiple lamps the surface texture, i.e. the gloss, can be further tuned by varying the distance and irradiance of the different lamps.

Preferably, the irradiance from each lamp unit in the skin cure step (3) is at least 5 mW/cm², more preferably at least 10 mW/cm², even more preferably at least 15 mW/cm², even more preferably at least 20 mW/cm², even more preferably at least 25 mW/cm², even more preferably at least 30 mW/cm²; and the irradiance from each lamp unit in the skin cure step (3) is preferably at most 500 mW/cm², more preferably at most 300 mW/cm², even more preferably at most 200 mW/cm².

The irradiating in the skin cure step (3) takes place under atmospheric conditions, i.e. in air, in other words not under inert gas conditions and/or not in an oxygen-reduced atmosphere.

A surface wrinkle pattern is formed at the coating surface after step (3). Without wishing to be bound by any theory, the surface wrinkle pattern is believed to be formed from microfolding of the coating skin layer, which microfold pattern preferably having a random microscopic pattern of peaks and valleys with average spacing between adjacent peaks and/or valleys shorter than 100 μm. By varying the radiation dose in step (3) and/or in the optional step (2a), the microfold pattern, for example the spacing between the adjacent peaks and/or valleys, can be further tuned and it is believed that by doing so, the gloss level and/or surface texture can be further tuned.

The step (4) of the method of the invention is performed by irradiating the partially cured surface layer with actinic radiation for finish curing of the coating, thereby affording the cured coating with the low gloss surface. Curing of coatings by actinic radiation, such as for example UV light or electron beam radiation is known in the industry. Actinic radiation is understood to be electromagnetic, ionizing radiation, in particular electron beams, UV light and visible light. The irradiating in step (4) is preferably carried out with E-beam or with UV light having substantial emission at wavelengths >280 nm. More preferably, the irradiating in step (4) is carried out with UV light of which at least 40% of the actinic radiation power of the applied radiation source is provided by UV light having wavelengths higher than 280 nm. Preferably also of the radiation power of the applied radiation source that is emitted in the wavelength range from 200 to 390 nm, at least 40% is emitted at wavelengths >280 nm; and preferably also of the radiation power of the applied radiation source that is emitted in the wavelength range from 231 to 390 nm, at least 40%, more preferably at least 50% is emitted at wavelengths >280 nm.

The light applied in step (4) preferably has a radiation dose from 150 to 2500 mJ/cm², more preferably has a radiation dose of at least 200 mJ/cm², or of at least 250 mJ/cm², or at least 300 mJ/cm². The upper limit of the radiation dose in step (4) is not critical, but is usually at most 2250 mJ/cm², or of at most 2000 mJ/cm².

Suitable radiation sources for step (4) are for example LED lamps with peak wavelength in the range from 350 to 450 nm or broad band UV lamps such as medium pressure mercury vapor lamp. Preferably the irradiating in the finish curing step (4) is carried out with UV light emitted from a broad band UV lamp. Examples of suitable broad band UV lamps for step (4) are medium pressure mercury vapor arc lamps or microwave powered lamps such as for example Fusion H lamp and Fusion H+ lamp, obtainable from Heraeus Noblelight.

For example, from the spectral profile of the Fusion H Bulb 13 mm 10 Inch lamp, having a broad band light spectrum, it can be calculated that, for example in the wavelength range of from 200 to 450 nm, only 28% of the emitted light has a wavelength from 231 to 280 nm and 62% is emitted at wavelengths >280 nm. This shows the critical difference from the UV light used in step (3). For a LED lamp having a single peak at the wavelength range of from 350 nm to 450 nm, 0% of the actinic light has a wavelength of from 231 to 280 nm and 100% is emitted at wavelengths >280 nm, which shows the critical difference from the UV light used in step (3).

The irradiating in step (4) takes place under atmospheric conditions, i.e. in air, in other words not under inert gas conditions and/or not in an oxygen-reduced atmosphere.

In optional step (2a) some of the reactive ethylenically unsaturated double bonds of the curable compounds of the radiation curable coating composition polymerize in the uncured coating layer obtained in step (2), so that the coating layer partially cures to a pre-gel or near gel point state. This process is also known as pre-curing. The optional pre-curing step (2a) is preferably performed by irradiating the radiation curable coating composition from step (2) with light having substantial emission at wavelengths >280 nm. More preferably, the irradiating in step (2a) is carried out with light of which at least 40% of the actinic radiation power of the applied radiation source is provided by light having wavelengths higher than 280 nm. More preferably, the optional pre-curing step (2a) is preferably performed by irradiating the radiation curable coating composition from step (2) with light having substantial emission at wavelengths >320 nm. Even more preferably, the irradiating in step (2a) is carried out with UV light of which at least 40%, more preferably at least 50%, even more preferably at least 60%, even more preferably at least 80% and even more preferably 100% of the actinic radiation power of the applied radiation source is provided by light having wavelengths higher than 320 nm.

The light applied in step (2a), when present, preferably has a radiation dose in the range from 1 to 200 mJ/cm², preferably has a radiation dose of at least 2 mJ/cm², or of at least 3 mJ/cm², and preferably has a radiation dose of at most 90 mJ/cm², or of at most 80 mJ/cm², or of at most 70 mJ/cm², or of at most 60 mJ/cm², or of at most 50 mJ/cm², or of at most 40 mJ/cm², or of at most 30 mJ/cm², or of at most 20 mJ/cm².

Suitable radiation sources for step (2a) are for example broad band UV lamps such as medium pressure mercury vapor lamp or LED lamps with peak wavelength in the range from 350 to 400 nm. Suitable medium pressure mercury vapor lamps are for example arc lamps or microwave powered lamps such as Fusion H lamps and Fusion H+ lamps, obtainable from Heraeus Noblelight. Preferably the irradiating in step (2a) is carried out with light emitted from a LED lamp with peak wavelength higher than 320 nm, such as for example a peak wavelength of 350 nm, or of 355 nm, or of 360 nm, or of 365 nm, or of 370 nm, or of 375 nm, or of 380 nm, or of 385 nm, or of 390 nm, or of 395 nm.

The irradiating in the optional pre-curing step (2a) preferably takes place under atmospheric conditions, i.e. in air, in other words not under inert gas conditions and/or not in an oxygen-reduced atmosphere.

The method of the present invention preferably takes place under atmospheric conditions, i.e. in air.

The skilled person will appreciate that that for the optional pre-cure step (2a), in which only a pre-gel or near gel point state of the coating should be achieved, preferably light having substantial emission higher than 350 nm, is used in the pre-cure step (2a) such as suitable LED lamps with peak wavelength higher than 350 nm, whereas for the through-cure step (4) preferably UV light having substantial emission in the wavelength range of from 281 to 390 nm is preferred such as broad band medium pressure mercury vapor lamps. This again exemplifies the differences in lamps best suited for the various steps.

The radiation doses as defined herein are the radiation doses of the light emitted in the wavelength range from 200 to 390 nm.

The method of the present invention allows to obtain surface coatings with a low gloss, whereby the gloss level can be controlled by adjusting dose condition in step (3) and/or in the optional step (2a). The gloss of the surface of the cured coating measured at 60° geometry of angle is less than or equal to 52 gloss units, preferably is in the range from 1 to 50 gloss units, or from 4 to 40 gloss units, or from 4 to 30 gloss units, or from 4 to 20 gloss units, or from 4 to 10 gloss units; and/or the gloss of the surface of the cured coating measured at 85° geometry of angle is less than or equal to 60 gloss units, preferably is in the range from 1 to 60 gloss units, or from 5 to 40 gloss units, or from 5 to 30 gloss units.

The aqueous coating composition used in the process of the invention is radiation curable. By radiation curable is meant that radiation is required to initiate crosslinking of the composition. The aqueous, radiation curable coating composition used in the process of the invention contains ethylenically unsaturated (C═C) bond functionality which under the influence of irradiation, preferably in combination with the presence of a photoinitiating system, can undergo crosslinking by free radical polymerisation. The aqueous, radiation curable coating composition as used in the present invention comprises (A) at least one polymer, and (B) at least one radiation curable diluents (also referred to as reactive diluents), and (C) water.

An acrylate functional group has the following formula:

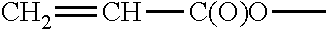

As used herein, the acrylate functionality of a compound is the number of acrylate functional groups per molecule of the compound.

A dispersion refers to a system with at least two phases where one phase contains discrete particles (colloidally dispersed particles) distributed throughout a bulk substance, the particles being the disperse phase and the bulk substance the continuous phase. The continuous phase of an aqueous dispersion is provided at least in part by water. Preferably the continuous phase of the dispersion of the invention comprises at least 75 wt. %, more preferably at least 80 wt. % of water (relative to the continuous phase).

The aqueous, radiation curable coating composition comprises at least one polymer, at least one reactive diluent, and water. The at least one polymer is preferably selected from the group consisting of polyurethane, radiation curable polyurethane, vinyl polymer, polyester, polyurethane-vinyl polymer hybrid, and any mixture thereof.

Preferably, the aqueous, radiation-curable coating composition used in the process of the invention is a dispersion comprising:
(A) Particles comprising at least one water-dispersed polymer, preferably selected from the group consisting of polyurethane, radiation curable polyurethane, vinyl polymer, polyester, polyurethane-vinyl polymer hybrid, and any mixture thereof and
(B) At least one radiation curable diluent (B) with a molar mass less than 800 g/mol and with an acrylate functionality of from 1 to 6, and
(C) Water and optionally organic solvent, whereby the optional organic solvent is present in an amount of at most 30 wt. %, based on the total amount of water and organic solvent, wherein the amount of (A) is from 30 to 95 wt. % and the amount of (B) is from 5 to 70 wt. %, based on the total amount of (A) and (B).

In a preferred embodiment of the invention, the aqueous, radiation curable coating composition comprises at least one non radiation curable polyurethane, at least one reactive diluent, and water. In another preferred embodiment of the invention, the aqueous, radiation curable coating composition comprises at least one radiation curable polyurethane, at least one reactive diluent, and water. In these preferred embodiments, the aqueous, radiation curable coating composition used in the process of the invention preferably comprises polyurethane (AA) in dispersed form, i.e. the composition preferably comprises dispersed particles of polyurethane (AA). Optionally the polyurethane (AA) is radiation curable.

### Water-Dispersed Polyurethane (AA)

The urea group (—NH—CO—NH—) concentration of the polyurethane (AA) is preferably at most 2.6 milli-equivalents per g of polyurethane (AA). The polyurethane (A) preferably has a urea group content of at most 1.3 meq per g of (AA) and preferably of at least 0.05 meq per g of (AA), most preferably of at least 0.2 meq per g of (AA).

In case polyurethane (AA) is free radical polymerizable (radiation curable), then the curable, ethylenically unsaturated bond concentration (also referred to as the C═C bond concentration) of the polyurethane (AA) present in the aqueous, radiation-curable coating composition of the present invention is preferably at least 0.25 milliequivalents per g of polyurethane (AA), preferably at least 0.4 milliequivalents per g of polyurethane (AA), more preferably at least 0.6 milliequivalents per g of polyurethane (AA) and preferably at most 4.5 milliequivalents per g of polyurethane (AA), more preferably at most 3.5 milliequivalents per g of polyurethane (A), and most preferably at most 2.5 milliequivalents per g of polyurethane (AA).

As used herein, the amount of radiation-curable, ethylenically unsaturated bonds in the polyurethane (AA) is determined by adding up all radiation-curable C═C functionality of the components from which the building blocks of the polyurethane (AA) are emanated. As used herein, the expression per g of polyurethane (AA) is determined by the total weight amount of components used to prepare the polyurethane from which the building blocks of the polyurethane are emanated.

The radiation-curable vinylic bonds, i.e. C═C bonds, in the polyurethane (AA) are preferably chosen from (meth)acryloyl groups and allylic groups, more preferably (meth)acryloyl groups, most preferably acryloyl groups.

Methods for preparing polyurethanes are known in the art and are described in for example the Polyurethane Handbook 2^{nd} Edition, a Carl Hanser publication, 1994, by G. Oertel. Usually an isocyanate-terminated polyurethane prepolymer is first formed which is then preferably chain extended with a nitrogen containing compound.

The polyurethane (AA) is preferably prepared from the reaction of at least the following components:
(AA1) At least one polyisocyanate,
(AA2) At least one isocyanate-reactive compound that contains at least one salt group which is capable to render the polyurethane (AA) dispersible in water and/or a functional group that can be converted into a salt group which is capable to render the polyurethane (A) dispersible in water,
(AA3) Optionally at least one isocyanate-reactive compound containing at least one non-ionic group which is capable to render the polyurethane (AA) dispersible in water,
(AA4) Optionally at least one isocyanate-reactive compound containing radiation-curable ethylenically unsaturated groups,
(AA5) At least one isocyanate-reactive polyol other than (AA2), (AA3) and (AA4) with an OH number of from 25 to 225 mg KOH/g solids,
(AA6) Optionally at least one isocyanate-reactive polyol other than (AA2), (AA3) and (AA4) having an OH number of higher than 225 mg KOH/g solids and lower than 1850 mg KOH/g solids, and
(AA7) Water and/or at least one nitrogen containing chain extender compound.

A preferred isocyanate-reactive group is a hydroxyl group.

### Component (AA1)

At least one polyisocyanate is used as component (AA1). The at least one polyisocyanate which is used according to the present invention is preferably selected from the group consisting of diisocyanates having the general formula Y (NCO) 2, where Y is a C4-12 divalent aliphatic hydrocarbon group, i.e. an aliphatic diisocyanate compound, a C6-15 divalent alicyclic hydrocarbon group, i.e. an alicyclic diisocyanate compound, a C6-15 divalent aromatic hydrocarbon group, i.e. an aromatic diisocyanate compound, or a C7-15 divalent araliphatic hydrocarbon group, i.e. an araliphatic diisocyanate compound.

Examples of suitable organic difunctional isocyanates (component (AA1)) include ethylene diisocyanate, 1,5-pentamethylenediisocyanate, 1,6-hexamethylene diisocyanate (HDI), isophorone diisocyanate (IPDI), cyclohexane-1,4-diisocyanate, dicyclohexylmethane diisocyanate (HMDI) such as 4,4′-dicyclohexylmethane diisocyanate (4,4′-H₁₂ MDI), p-xylylene diisocyanate, p-tetramethylxylene diisocyanate (p-TMXDI) (and its meta isomer m-TMXDI), 1,4-phenylene diisocyanate, 2,4-toluene diisocyanate, 2,6-toluene diisocyanate, hydrogenated 2,4-toluene diisocyanate, hydrogenated 2,6-toluene diisocyanate, 4,4′-diphenylmethane diisocyanate (4,4′-MDI), 2,4′-diphenylmethane diisocyanate, 3 (4)-isocyanatomethyl-1-methyl cyclohexyl isocyanate (IMCI) and 1,5-naphthylene diisocyanate. Preferred organic difunctional isocyanates are IPDI, HMDI and HDI. Mixtures of organic difunctional isocyanates can also be used.

In general, the amount of component (AA1) is from 5 to 55 wt. %, preferably from 10 to 45 wt. %, most preferably from 15 to 40 wt. %, based on the weight of the polyurethane (AA).

### Component (AA2)

At least one isocyanate-reactive compound that contains at least one salt group, preferably a salt of an acidic group, which is capable to render the polyurethane (AA) dispersible in water and/or at least one functional group, preferably an acidic group, that can be converted, by reaction with a neutralizing agent, into a salt group which is capable to render the polyurethane (AA) dispersible in water is used as component (AA2).

In general, the amount of component (AA2) is from 1 to 15 wt. %, preferably from 2 to 12 wt. % and even more preferably from 3 to 10 wt. %, based on the weight of the polyurethane (AA).

According to the present invention, the acidic group is preferably selected from a carboxylic acid group, a sulfonic acid group and/or a phosphoric acid group. Component (AA2) is preferably a compound having two or more hydroxy groups and/or two or more amino groups. Preferably at least one compound having two or more hydroxy groups is used as component (AA2). A combination of at least one carboxylic acid group-containing compound and at least one sulfonic acid group-containing compound may be used. Preferred components (AA2) are dihydroxy alkanoic acids and diamine sulfonate salts.

Preferably, at least one carboxylic acid group containing compound is used as component (AA2).

In case component (AA2) contains at least one functional group that can be converted by reaction with a neutralizing agent into a salt group, the neutralizing agent used to deprotonate (neutralize) the functional groups (preferably carboxylic acid groups, sulfonic acid groups and/or phosphoric acid groups, more preferably carboxylic acid groups) is preferably selected from the group consisting of ammonia, a (tertiary) amine, a metal hydroxide and any mixture thereof. Suitable tertiary amines include triethylamine and N, N-dimethylethanolamine. Suitable metal hydroxides include alkali metal hydroxides, for example lithium hydroxide, sodium hydroxide and potassium hydroxide. Preferably, at least 30 mol %, more preferably at least 50 mol % and most preferably at least 70 mol % of the total molar amount of the neutralizing agent is alkali metal hydroxide, preferably selected from the group consisting of lithium hydroxide, sodium hydroxide, potassium hydroxide and any mixture thereof. Preferably the neutralizing agent used to deprotonate (neutralize) the carboxylic acid groups, sulfonic acid groups and/or phosphoric acid groups is an alkali metal hydroxide. As used herein, the neutralizing agent (if any) is not to be considered a component from which the building blocks of the polyurethane (AA) are emanated. Thus, the amount of neutralizing agent (if any) used in the preparation of the polyurethane (AA) is not taking into account for the calculation of the weight of the polyurethane (AA).

In an embodiment of the invention, component (AA2) comprises or essentially consists of or consists of at least one diamine sulfonate salt. In this embodiment, usually an isocyanate-terminated polyurethane pre-polymer is first formed by the reaction of components (AA1) and (AA5), and optionally (AA4) and optionally (AA3) and optionally (AA6) which is then further reacted with the diamine sulfonate salt (AA2) and water and optionally a nitrogen chain extender compound (AA7). A preferred diamine sulfonate salt is the sodium salt of 2-[(2-aminoethyl)amino]ethanesulfonic acid.

In a preferred embodiment of the invention, component (AA2) comprises or essentially consists of or consists of at least one dihydroxy alkanoic acid. In this embodiment, usually an isocyanate-terminated polyurethane pre-polymer is first formed by the reaction of components (AA1), (AA2) and (AA5), and optionally (AA4) and optionally (AA3) and optionally (AA6) which is then chain extended with water and/or a nitrogen chain extender compound (AA7).

Preferred dihydroxy alkanoic acids are α,α-dimethylolpropionic acid and/or α,α-dimethylolbutanoic acid. More preferably, the dihydroxy alkanoic acid(s) is α,α-dimethylolpropionic acid.

In general the amount of acidic groups present in the polyurethane (AA) is preferably such that the acid value of the polyurethane (AA) is in the range from 5 to 50, more preferably from 10 to 40 mg KOH/g solids of the polyurethane (AA), even more preferably from 15 to 30 mg KOH/g solids of the polyurethane (AA).

### Component (AA3)

Optionally at least one isocyanate-reactive compound containing at least one non-ionic group which is capable to render the polyurethane (AA) dispersible in water, is used as component (AA3).

The polyurethane (AA) may further be stabilized in the dispersion through non-ionic functionality incorporated into the polyurethane (AA). Thus, the polyurethane (AA) may at least for a part be non-ionically stabilized by chemically incorporating non-ionic groups into the polyurethane (AA) to provide at least a part of the hydrophilicity required to enable the polyurethane (AA) to be stably dispersed in the aqueous dispersing medium. Preferred non-ionic water-dispersing groups are polyethylene oxide groups.

Preferred components (AA3) are polyethylene glycols having at least 5 ethylene oxide repeating units, preferably at least 10, more preferably at least 15 ethylene oxide repeating units and preferably at most 120, more preferably at most 80 and even more preferably at most 40 ethylene oxide repeating units. More preferred components (AA3) are polyethylene glycols having from 10 to 60 and preferably from 15 to 30 ethylene oxide repeating units.

Non-limited examples of suitable components (AA3) include Ymer™ N120 available from Perstorp and MPEG 750.

In case component (AA3) is used to prepare the polyurethane (AA), the amount of component (AA3) is in general from 1 to 25 wt. %, preferably from 1 to 15 wt. %, more preferably from 1 to 12 wt. %, most preferably from 1 to 5 wt. %, based on the weight of the polyurethane (AA).

### Component (AA4)

In case polyurethane (AA) is free radical polymerizable (radiation curable), then at least one isocyanate-reactive compound containing radiation-curable ethylenically unsaturated groups is used as component (AA4). Component (AA4) is preferably selected from compounds containing at least one isocyanate-reactive group and at least one (meth)acryloyl ester functional group, preferably at least one acryloyl ester functional group. Suitable components (AA4) are exemplified by polyester acrylates, epoxy acrylates, polyether acrylates (such as polypropyleneglycol acrylate and polyethylene glycol acrylate), hydroxyethyl(meth)acrylate, hydroxypropyl(meth)acrylate, hydroxybutyl(meth)acrylate, hydroxy functional (poly)caprolactone acrylates, trimethylolpropane di(meth)acrylates and their polyethoxylated and polypropoxylated equivalents, pentaerythritol tri(meth)acrylate and their polyethoxylated and polypropoxylated equivalents, ditrimethylolpropane tri(meth)acrylate and their polyethoxylated and polypropoxylated equivalents. Such exemplary components (AA4) may be used alone, or alternatively, in combinations of two or more. Preferred components (AA4) are selected from the group consisting of hydroxyethyl(meth)acrylate, hydroxypropyl(meth)acrylate, hydroxybutyl(meth)acrylate and any mixture thereof and/or from the group consisting of trimethylolpropane di(meth)acrylates, pentaerythritol tri(meth)acrylate, ditrimethylolpropane tri(meth)acrylate and their polyethoxylated and polypropoxylated equivalents and any mixture thereof. More preferred components (AA4) are selected from the group consisting of hydroxyethylacrylate, hydroxypropylacrylate, hydroxybutylacrylate and any mixture thereof and/or from the group consisting of trimethylolpropane diacrylates, pentaerythritol triacrylate, ditrimethylolpropane triacrylate and their polyethoxylated and polypropoxylated equivalents and any mixture thereof.

In case polyurethane (AA) is free radical polymerizable (radiation curable), then the amount of component (AA4) is preferably chosen such that the polyurethane (AA) has a radiation-curable, ethylenically unsaturated bond concentration of at least 0.25 milliequivalents per g of polyurethane (AA), preferably at least 0.4 milliequivalents per g of polyurethane (AA), more preferably at least 0.6 milliequivalents per g of polyurethane (AA) and preferably at most 4.5 milliequivalents per g of polyurethane (AA), more preferably at most 3.5 milliequivalents per g of polyurethane (A), and most preferably at most 2.5 milliequivalents per g of polyurethane (AA).

### Component (AA5)

At least one isocyanate-reactive compound having an OH number of from 25 to 225 mg KOH/g solids and being different from (AA2), (AA3) and (AA4) is used as component (AA5). Preferred components (AA5) are polyols which may be selected from any of the chemical classes of polyols that can be used in polyurethane synthesis. In particular the polyol may be a polyester polyol, a polyesteramide polyol, a polyether polyol, a polythioether polyol, a polycarbonate polyol, a polyacetal polyol, a polyvinyl polyol and/or a polysiloxane polyol. Preferred are the polyester polyols, polyether polyols and polycarbonate polyols. Preferably the OH number of component (AA5) is within the range of from 45 to 125 mg KOH/g solids.

In general, the amount of component (AA5) is from 10 to 80 wt. %, preferably from 20 to 70 wt. %, more preferably from 25 to 65 wt. %, and even more preferably from 25 to 60 wt. %, based on the weight of the polyurethane (AA).

### Component (AA6)

Optionally at least one isocyanate-reactive compound having an OH number higher than 225 mg KOH/g solids and lower than 1850 mg KOH/g solids and being different from (AA2), (AA3) and (AA4), is used as component (AA6).

Examples of suitable components (AA6) include neopentylglycol (NPG), cyclohexanedimethanol (CHDM), butanediol, hexanediol and trimethylolpropane.

In case component (AA6) is used to prepare the polyurethane (AA), the amount of component (AA6) is in general from 0.5 to 10 wt. %, preferably from 0.5 to 8 wt. %, more preferably from 0.5 to 6 wt. %, most preferably from 0.5 to 4 wt. %, based on the weight of the polyurethane (AA).

### Component (AA7)

Water and/or at least one nitrogen containing chain extender compound is used as chain extender component (AA7).

For water extension, two NCO groups will form one urea bond. First a NCO group reacts with water to form an unstable carbamic acid intermediate that decomposes to CO₂ and an amine group, which amine group will then react with another NCO group to form a urea group. However, water extension is very slow compared to chain extension using a nitrogen containing chain extender. Therefore, if a nitrogen containing chain extender compound is applied, it is assumed for the calculation of the urea group concentration that the isocyanate groups of the polyurethane prepolymer first react with the nitrogen containing chain extender and that during and/or after dispersion the isocyanate groups still present on the polyurethane prepolymer react with water to form a urea group.

Examples of suitable nitrogen containing chain extenders include amino-alcohols, primary or secondary diamines or polyamines (including compounds containing a primary amino group and a secondary amino group), hydrazine and substituted hydrazines. Examples of such chain extender compounds useful herein include 2-(methylamino)ethylamine, aminoethyl ethanolamine, aminoethylpiperazine, diethylene triamine, and alkylene diamines such as ethylene diamine and 1,6-hexamethylenediamine, and cyclic amines such as isophorone diamine. Also compounds such as hydrazine, azines such as acetone azine, substituted hydrazines such as, for example, dimethyl hydrazine, 1,6-hexamethylene-bis-hydrazine, carbodihydrazide, hydrazides of dicarboxylic acids, such as adipic acid dihydrazide, oxalic acid dihydrazide, and isophthalic acid dihydrazide, Hydrazides made by reacting lactones with hydrazine, bis-semi-carbazide, and bis-hydrazide carbonic esters of glycols may be useful. Water-soluble nitrogen containing chain extenders are preferred.

Preferably the nitrogen containing chain extender compound is selected from the group consisting of amino-alcohols, primary or secondary diamines, hydrazine, substituted hydrazines, substituted hydrazides and any mixture thereof.

Where the chain extender is other than water, for example, a hydrazine, it may be added to the aqueous dispersion of the isocyanate-terminated polyurethane prepolymer or, alternatively, it may already be present in the aqueous medium when the isocyanate-terminated polyurethane prepolymer is dispersed therein. The chain extension may be conducted at convenient temperatures from about 5° C. to 95° C. or, more preferably, from about 10° C. to 60° C.

The total amount of nitrogen containing chain extender compound employed, if used, should be such that the ratio of active hydrogens in the chain extender to isocyanate groups in the polyurethane prepolymer preferably is in the range from 0.1:1 to 2:1, more preferably from 0.6:1 to 1.4:1 and especially preferred from 0.8 to 1.2.

Preferably, component (AA7) is water or water and at least one nitrogen containing chain extender with a NHₓ (wherein x is 1 or 2) functionality of 2 or 3, more preferably with a NHₓ functionality of 2, wherein for a hydrazide the NH groups connected to the carbonyl groups are not considered chain extending groups. More preferably, component (AA7) comprises at least one nitrogen containing chain extender with a NHₓ (wherein x is 1 or 2) functionality of 2 or 3, more preferably with a NHₓ functionality of 2, wherein for a hydrazide the NH groups connected to the carbonyl groups are not considered chain extending groups. Even more preferably, component (AA7) is water and at least one nitrogen containing chain extender with a NHₓ (wherein x is 1 or 2) functionality of 2 or 3, more preferably with a NHₓ functionality of 2, wherein for a hydrazide the NH groups connected to the carbonyl groups are not considered chain extending groups. The nitrogen containing chain extender is preferably selected from the group consisting of diamines and/or dihydrazides.

In the present invention, the water-dispersed polyurethanes (AA) preferably have a weight-average molecular weight M_{w} of at least 15,000 g/mol, more preferably of at least 20,000 g/mol, even more preferably of at least 30,000 g/mol determined with size exclusion chromatography.

In another preferred embodiment of the invention, the aqueous, radiation curable coating composition comprises a vinyl polymer system, at least one reactive diluent, and water.

### Vinyl Polymer System (AB)

In this preferred embodiment, the aqueous, radiation curable coating composition used in the process of the invention preferably comprises a vinyl polymer system (AB) in dispersed form, i.e. the composition preferably comprises dispersed particles of a vinyl polymer system (AB). The vinyl polymer system (AB) comprises one or more vinyl polymers with preferably a glass transition temperature T_{g} of less than or equal to 77° C. in an amount of at least 50 wt. %, preferably at least 65 wt. %, based on the amount of the polymer system (AB). The glass transition temperature T_{g} is determined with Differential Scanning calorimetry

Accordingly, the amount of vinyl polymer(s) with a glass transition temperature T_{g} of less than or equal to 77° C. present in the vinyl polymer system (AB) is from 50 to 100 wt. %, preferably from 65 to 100 wt. %; and the amount of vinyl polymer(s) with a glass transition temperature T_{g} higher than 77° C. that is allowed to be present in the vinyl polymer system (AB) is from 0 to 50 wt. %, preferably from 0 to 35 wt. %.

The vinyl polymer system (AB) present in the aqueous, radiation-curable coating composition to be used in the present invention preferably has a theoretical acid value from 5 to 105 mg KOH/gram (AB).

The vinyl polymer system (AB) present in the aqueous, radiation-curable coating composition to be used in the present invention is essentially free of radiation-curable, ethylenically unsaturated bonds.

By a vinyl polymer is meant generally herein a polymer derived from the addition polymerisation (normally by a free-radical process) of at least one olefinically unsaturated monomer. By a vinyl monomer is therefore meant herein an olefinically unsaturated monomer.

The at least one vinyl polymer of the vinyl polymer system (AB) is preferably obtained by solution, emulsion or suspension polymerization. In case vinyl polymer is obtained by solution polymerization, the applied solvent, preferably a volatile solvent, is removed during and/or after emulsification of vinyl polymer. Preferably the process to prepare the at least one vinyl polymer is free of organic solvent. As such, the at least one vinyl polymer is preferably obtained by emulsion or suspension polymerization. Most preferably the at least one vinyl polymer is obtained by emulsion polymerization, preferably the at least one vinyl polymer is obtained in an aqueous emulsion polymerisation process. Such an aqueous emulsion polymerisation process is, in itself, well known in the art and need not be described in great detail. Suffice to say that such a process involves polymerizing the monomers in an aqueous medium and conducting polymerisation using a free-radical yielding initiator and (usually) appropriate heating (e.g. 30 to 120° C.) and agitation (stirring) being employed. The aqueous emulsion polymerisation can be effected using one or more conventional emulsifying agents, these being surfactants. Anionic, non-ionic, and anionic-non-ionic surfactants can be used, and also combinations of the three types; cationic surfactants can also be used.

In case the at least one vinyl polymer is prepared via emulsion polymerization, the radical polymerization to obtain vinyl polymer is conducted using a free radical initiator, appropriate heating and agitation (stirring). The polymerisation can employ conventional free radical initiators [e.g. hydrogen peroxide, t-butyl-hydroperoxide, cumene hydroperoxide, persulphates such as ammonium, potassium and sodium salts of persulphate; redox systems may be used; combinations such as t-butyl hydroperoxide isoascorbic acid and FeEDTA are useful; the amount of initiator, or initiator system, is generally 0.05 to 3% based on the weight of total monomers charged. The molecular weight of vinyl polymer can be controlled by the use of well-known chain transfer agents. Preferred chain transfer agents can include mercaptanes and alkyl halogenides. More preferred, the chain transfer agent is selected from the group of lauryl mercaptane, 3-mercapto propionic acid, i-octyl thioglycolate, mercaptoethanol, tetrabromo methane, or tribromo methane. Most preferred the chain transfer agent is a mercaptane, selected from the group of lauryl mercaptane, 3-mercapto propionic acid, i-octyl thioglycolate, and mercaptoethanol.

The polymerization of the vinyl monomers to form the polymer system (AB) can be run in different ways. One can envisage straight emulsions, with only one monomer feed, sequential polymers resulting in a phase separated particle morphology, and oligomer-polymer emulsions where preferably one of the polymer phases contains significantly more acid functionality than the other phase(s).

The polymer system may have a phase separated particle morphology obtained by the polymerization of at least a first monomer feed and a different second monomer feed. The polymer system (AB) preferably comprises at least two vinyl polymers. In case the polymer system (AB) comprises at least two vinyl polymers, preferably, the at least two vinyl polymers differ in glass transition temperature (T_{g}) by at least 20° C., and preferably by at most 200° C. In an embodiment of the invention, the polymer system (AB) comprises at least two vinyl polymers with a difference in acid value, whereby one vinyl polymer has an acid value of at least 13 mg KOH/g of vinyl polymer and at least one of the other vinyl polymers preferably has an acid value of no more than 13 mg KOH/g of vinyl polymer.

An emulsion polymerisation for making the at least one vinyl polymer may be carried out using an “all-in-one” batch process (i.e. a process in which all the materials to be employed are present in the polymerisation medium at the start of polymerisation) or a semi-batch process in which one or more of the materials employed (usually at least one of the monomers) is wholly or partially fed to the polymerisation medium during the polymerisation. In-line mixing for two or more of the materials employed may also be used.

The pH of the final polymer emulsion comprising the polymer system (AB) is preferably between 5 and 9, more preferred between 7 and 9. In the case of an emulsion polymerization process, the pH is raised preferably during the monomer feed or at the end of the polymerization using ammonia, organic amines or inorganic bases. Preferred bases are ammonia, dimethyl ethanol amine, and lithium, sodium, or potassium hydroxide salts. The most preferred base is ammonia.

The vinyl polymer system (AB) preferably has a weight-average molecular weight M_{w} of at least 5,000 g/mol, more preferably of at least 10,000 g/mol, even more preferably at least 20,000 g/mol, even more preferably at least 30,000 g/mol. The upper limit of the weight-average molecular weight is not critical, but is preferably of at most 1,000,000 g/mol, more preferably of at most 500,000 g/mol, even more preferably at most 250,000 g/mol. The weight-average molecular weight M_{w} is determined by size exclusion chromatography (SEC).

The vinyl polymer(s) of the vinyl polymer system (AB) is preferably a (meth)acrylic polymer. The term (meth)acrylic polymer as used herein denotes a polymer obtained by polymerisation of at least one polymer precursor comprising an acrylate (—HC═CHC(═O)O—) and/or a methacrylate (—HC═C(CH3)C(═O)O—) moiety, resulting in an polymer comprising —(CH2-CHC(═O)O—)— and/or a —(CH2-C(CH3)C(═O)O—)— moieties. The (meth)acrylic polymer may comprise other moieties including arylalkylenes such as styrene, although in an embodiment of the invention it is preferred that the compositions are substantially free of arylalkylenes.

The polymer system (AB) preferably comprises
(AB1) carboxylic acid functional olefinically unsaturated monomer, and
(AB2) olefinically unsaturated monomer, different from (A1).

Monomers (AB1) are preferably selected from the group consisting of itaconic acid, itaconic anhydride, mono-alkylesters of itaconic acid, mono-aryl esters of itaconic acid, acrylic acid, methacrylic acid, ß-carboxyethyl acrylate and combinations thereof, more preferably, monomer (AB1) is acrylic acid and/or methacrylic acid and most preferably, monomer (A1) is methacrylic acid.

Monomers (AB2) are preferably selected from the group consisting of acrylates, methacrylates, arylalkylenes, itaconates and any mixture thereof. Preferably at least 30 weight percent, more preferably at least 40 weight percent, more preferably at least 50 weight percent, more preferably at least 60 weight percent and even more preferably at least 70 weight percent of the total amount of monomers (AB2) is selected from the group consisting of methyl methacrylate, n-butyl acrylate, n-butyl methacrylate, 2-ethyl hexyl acrylate, 2-octyl acrylate, styrene and mixtures of two or more of said monomers. Preferably at least 30 weight percent, more preferably at least 40 weight percent, more preferably at least 50 weight percent, more preferably at least 60 weight percent and even more preferably at least 70 weight percent of the total amount of monomers (AB2) is selected from the group consisting of methyl methacrylate, n-butyl acrylate, n-butyl methacrylate, 2-ethyl hexyl acrylate, 2-octyl acrylate and mixtures of two or more of said monomers.

In a preferred embodiment of the invention, the aqueous, radiation curable coating composition comprises at least one polyurethane-vinyl polymer hybrid, at least one reactive diluent, and water.

### Polyurethane-Vinyl Polymer Hybrid (AC)

The at least one hybrid (AC) of at least one polyurethane and at least one vinyl polymer is obtained by free-radical polymerization of one or more vinyl monomers in the presence of at least one polyurethane, preferably in the presence of at least one water-dispersed polyurethane, as described herein below.

The reactive diluent (B) is added after having carried out the free-radical polymerization of vinyl monomer(s) to obtain the vinyl polymer of the polyurethane-vinyl polymer hybrid. The polyurethane is preferably prepared in the presence of at least part of the one or more vinyl monomers used to prepare the vinyl polymer.

The vinyl polymer is advantageously formed in-situ by polymerizing the one or more vinyl monomers in the presence of a preformed aqueous polyurethane dispersion.

By a polyurethane-vinyl polymer hybrid is meant that a vinyl polymer is prepared by the free-radical polymerization of vinyl monomer(s) in the presence of the polyurethane by forming an aqueous dispersion of said polyurethane resin and polymerising one or more vinyl monomers to form a vinyl polymer such that said vinyl polymer becomes incorporated in-situ into said aqueous dispersion by virtue of polymerising vinyl monomer(s) used to form the vinyl polymer in the presence of the polyurethane resin. Vinyl monomer is added before, during and/or after preparation of the polyurethane and the vinyl monomer is polymerized by adding a free radical initiator to polymerize the vinyl monomer in the presence of the polyurethane.

The weight ratio of the polyurethane to vinyl polymer present in the polyurethane-vinyl polymer hybrid (AC) is in the range of from 25:75 to 95:5, preferably from 30:70 to 90:10, more preferably from 40:60 to 88:12, more preferably from 50:50 to 85:15, more preferably from 65:35 to 80:20.

The theoretical acid value of the polyurethane-vinyl polymer hybrid (AC) is preferably within the range of from 3 to 45 mg KOH/g of the hybrid (AC), preferably from 4 to 40 mg KOH/g of the hybrid (A), more preferably from 5 to 35 mg KOH/g of the hybrid (AC), more preferably from 6 to 28 mg KOH/g of the hybrid (AC).

### Polyurethane Part of Hybrid (AC) (AC-PU)

The urea group (—NH—CO—NH—) concentration of the polyurethane (AC-PU) is preferably at least 0.1 and at most 1.9 milli-equivalents per g of polyurethane. The polyurethane (AC-PU) preferably has a urea group content of at most 0.9 meq per g of polyurethane and preferably of at least 0.2 meq per g of polyurethane, more preferably of at least 0.4 meq per g of polyurethane.

The polyurethane (AC-PU) is preferably prepared from the reaction of at least the following components:
(AA1) At least one polyisocyanate,
(AA2) At least one isocyanate-reactive compound that contains at least one salt group which is capable to render the polyurethane dispersible in water and/or a functional group that can be converted into a salt group which is capable to render the polyurethane dispersible in water, preferably acid functional,
(AA3) Optionally at least one isocyanate-reactive compound containing at least one non-ionic group which is capable to render the polyurethane dispersible in water,
(AA5) At least one isocyanate-reactive polyol other than (AA2) and (AA3) having an OH number of from 25 to 225 mg KOH/g solids,
(AA6) Optionally at least one isocyanate-reactive polyol other than (AA2) and (AA3) having an OH number higher than 225 mg KOH/g solids and lower than 1850 mg KOH/g solids, and
(AA7) Water and/or at least one nitrogen containing chain extender compound, whereby type and amount of components (AA1), (AA2), (AA3), (AA5), (AA6) and (AA7) are as described above.

A preferred isocyanate-reactive group is a hydroxyl group.

### Vinyl Polymer of Polymer Hybrid (AC-VP)

The vinyl polymer(s) (AC-VP) of the hybrid is obtained by polymerizing of vinyl monomer(s) using a conventional free radical yielding initiator system. Suitable initiators are described above.

Preferably at least 80 wt. %, more preferably at least 95 wt. % and most preferably 100 wt. % of the total weight of vinyl monomers used are of α,β-mono-unsaturated vinyl monomers.

Examples of vinyl monomers include but are not limited to 1,3-butadiene, isoprene; trifluoro ethyl (meth)acrylate (TFEMA); dimethyl amino ethyl (meth)acrylate (DMAEMA); styrene, α-methyl styrene, (meth)acrylic amides and (meth)acrylonitrile; vinyl halides such as vinyl chloride; vinylidene halides such as vinylidene chloride; vinyl ethers; vinyl esters such as vinyl acetate, vinyl propionate, vinyl laurate; vinyl esters of versatic acid such as VeoVa 9 and VeoVa 10 (VeoVa is a trademark of Resolution); heterocyclic vinyl compounds; alkyl esters of mono-olefinically unsaturated dicarboxylic acids such as di-n-butyl maleate and di-n-butyl fumarate; dialkylitaconates such as dimethyltaconate, diethylitaconate, dibutylitaconate and in particular, esters of acrylic acid and methacrylic acid of formula CH₂═CR⁴—COOR⁵ wherein R⁴ is H or methyl and R⁵ is optionally substituted alkyl of 1 to 20 carbon atoms (more preferably from 1 to 8 carbon atoms) or cycloalkyl of 3 to 20 carbon atoms (more preferably from 3 to 6 carbon atoms) examples of which are methyl (meth)acrylate, ethyl (meth)acrylate, butyl (meth)acrylate (all isomers), octyl (meth)acrylate (all isomers), 2-ethylhexyl (meth)acrylate, isopropyl (meth)acrylate and n-propyl (meth)acrylate. Preferred monomers of formula CH2═CR⁴—COOR⁵ include methyl (meth)acrylate, ethyl (meth)acrylate, butyl (meth)acrylate (all isomers), octyl (meth)acrylate (all isomers), ethyl hexyl acrylate (all isomers) and isobornyl (meth)acrylate.

The vinyl monomers may include vinyl monomers carrying functional groups such as cross-linker groups and/or water-dispersing groups. Such functionality may be introduced directly in the vinyl polymer by free-radical polymerisation, or alternatively the functional group may be introduced by a reaction of a reactive vinyl monomer, which is subsequently reacted with a reactive compound carrying the desired functional group. Examples of suitable vinyl monomers providing crosslinking groups include acrylic and methacrylic monomers having at least one free carboxyl or hydroxyl group, epoxy, acetoacetoxy or carbonyl group, such as acrylic acid and methacrylic acid, glycidyl acrylate, glycidyl methacrylate, aceto acetoxy ethyl methacrylate, allyl methacrylate, tetraethylene glycol dimethacrylate, divinyl benzene and diacetone acrylamide.

Vinyl monomers providing ionic or potentially ionic water-dispersing groups which may be used as additional vinyl monomers include but are not limited to (meth)acrylic acid, itaconic acid, maleic acid, citraconic acid and styrenesulphonic acid.

Vinyl monomers providing non-ionic water-dispersing groups include alkoxy polyethylene glycol (meth)acrylates, preferably having a number average molecular weight of from 140 to 3000, may also be used. Examples of such monomers which are commercially available include ω-methoxypolyethylene glycol (meth)acrylates. The at least one vinyl polymer of the hybrid (AC) preferably has a calculated glass transition temperature T_{g} of from −55° C. to 115° C., more preferably from 45° C. to 115° C.

As used herein, the glass transition temperature is determined by calculation by means of the Fox equation. Thus, the T_{g} in Kelvin, of a copolymer having “n” copolymerised comonomers is given by the weight fractions W of each comonomer type and the T_{g}'s of the homopolymers (in Kelvin) derived from each comonomer (as listed, for example, in J. Brandrup, E. H. Immergut, Polymer handbook 4^{th} edition p. VI 193) according to the equation:

$$\frac{1}{Tg} = \frac{{W}_{1}}{{Tg}_{1}} + \frac{{W}_{2}}{{Tg}_{2}} + … + \frac{W \text{?}}{Tg \text{?}}$$

$$\text{?} \text{indicates text missing or illegible when filed}$$

The calculated T_{g} in Kelvin may be readily converted to ° C. Preferably, at least 30 wt. %, more preferably at least 70 wt. % of the total amount of vinyl monomer(s) used to prepare the vinyl polymer is selected from the group consisting of methyl methacrylate, n-butyl acrylate, n-butyl methacrylate, 2-ethyl hexyl acrylate, 2-octyl acrylate, styrene and mixtures of two or more of said monomers.

The vinyl polymer of the hybrid (AC-VP) preferably has a theoretical acid value of from 0 to 10 mg KOH/g solids of vinyl polymer, more preferably less than 3 mg KOH/g solids of vinyl polymer.

The polyurethane-vinyl polymer hybrid (AC) present in the aqueous, radiation-curable coating composition of the present invention is essentially free of radiation-curable, ethylenically unsaturated bonds.

In another preferred embodiment of the invention, the aqueous, radiation curable coating composition comprises at least one polyester, at least one reactive diluent, and water. In this preferred embodiment, the aqueous, radiation curable coating composition used in the process of the invention preferably comprises polyester (AD) in dispersed form, i.e. the composition preferably comprises dispersed particles of polyester (AD).

### Water-Dispersed Polyester (AD)

The at least one water-dispersed polyester (AD) preferably has a glass transition temperature T_{g}, determined using Differential Scanning, of less than or equal to 70° C. The at least one water-dispersed polyester (AD) has a glass transition temperature T_{g} of preferably at least −50° C., more preferably of at least −10° C.

Generally the at least one water-dispersed polyester (AD) preferably has an acid value AV, of less than or equal to 100 mg KOH/g of the polyester (AD), preferably at most 70 mg KOH/g of the polyester (AD). The at least one water-dispersed polyester (AD) preferably has an acid value of at least 0.2 mg KOH/g of the polyester (AD), more preferably of at least 0.5 mg KOH/g of the polyester (AD).

The hydroxyl value of the at least one water-dispersed polyester (AD) may range from 0 to 250 mg KOH/g of the polyester (AD). Preferably the hydroxyl value of the at least one water-dispersed polyester (AD) is preferably at most 150 mg KOH/g of the polyester (AD), and preferably at least 1 mg KOH/g of the polyester (AD).

The at least one water-dispersed polyester (AD) preferably has a number average molecular weight Mₙ, determined using Size Exclusion Chromatography (SEC), of at at least 1000 g/mol, preferably at least 2500 g/mol, and preferably of at most 15000 g/mol, more preferably, more preferably of at most 11000 g/mol.

Preferably, the at least one water-dispersed polyester (AD) is amorphous. With amorphous is meant herein that the polyester has a melting enthalpy (ΔHm), determined using Differential Scanning calorimetry as described further herein, lower than 40 J/g. More preferably, the at least one water-dispersed polyester (AD) is fully amorphous, i.e. does not have a melting temperature (Tm), determined using Differential Scanning calorimetry.

By the term ‘polycondensation’ is meant in the specification condensation polymerization as this type of polymerization is known to one of ordinary skill in the art, and is meant to refer to one or both of: a) polyesterification, and b) polytransesterification, as each of a) and b) are known to one of ordinary skill in the art.

The water-dispersed polyester (AD) is obtained by
(1) preparing a polyester, and
(2) dispersing the polyester in water.

The polyester can be produced by polycondensation comprising a single or multiple reaction steps in presence of a solvent (e.g. xylene as azeotrope) and/or in the bulk synthesis. Preferably polyester according to the invention is prepared by bulk synthesis polycondensation reaction.

The polycondensation usually takes place under a nitrogen atmosphere at temperatures in a range typically of from 160 to 260° C. Catalysts such as dibutyl tin oxide, butyl chlorotin dihydroxide, butyl stannoic acid or tetrabutoxytitanate and antioxidants such as phosphorous acid, trisnonylphenylphosphite or triphenylphosphite can be added as additives. During the reaction, water is released and is preferably removed through distillation. The desired degree of esterification can be achieved by applying azeotropic distillation and/or vacuum distillation.

The obtained polyester is subsequently dispersed to obtain a water-dispersed polyester (AD).

Usually it is necessary for the polyester to contain ionic groups in order to become dispersed in aqueous medium.

One way to obtain the ionic groups is to neutralize the carboxylic groups of the polyester with a neutralising agent. Suitable neutralizing agents include but are not limited to ammonia, dimethyl ethanol amine, triethyl amine, aminomethyl propanol, tributyl amine, sodium hydroxide and potassium hydroxide. The neutralizing agent can be directly added to the polyester followed by the addition of water or first dissolved in the aqueous medium and then added to the polyester. It is also possible to add the polyester to the neutralizing agent aqueous medium.

Another way is to build carboxylic acids containing ionic functional groups like 5-(sulfo) isophthalic acid sodium salt and 5-(sulfo) isophthalic acid lithium salt into the backbone of the polyester. In this case the addition of the neutralizing agent is not necessary and the polyester dispersion can be obtained by simply adding the water.

Sometimes isopropanol, 2-butanol, 2-butoxyethanol, acetone or methyl ethyl ketone or 2-(2-butoxyethoxy) ethanol can be used as co-solvents to ease the dispersion process.

It is also possible to obtain waterborne dispersion or emulsion of the polyester by using at least one external surfactant in the aqueous medium. The process and surfactants that may be used are well known to those skilled in the art. Preferably a mixture of surfactants is used, more preferably a combination of anionic and non-ionic surfactant systems.

Examples of surfactant systems that may be used to emulsify the polyester are described in US2003-144397 (I CI) and in ‘Emulsification and Polymerization of Alkyd Resins’ by Jan W. Gooch, Springer, first edition 1 Dec. 2001 (ISBN 0306467178) and the contents of both of these are incorporated herein by reference.

Yet another way to obtain a waterborne dispersion of the polyester is by using the solvent assistance process, where the polyester is first dissolved in low boiling point solvent (for example acetone or methylethylketone). Ones the polyester is dissolved, the desired amount of water can be added to the solution, followed by distilling of the organic solvent by means of vacuum.

The temperature during the dispersion process can be in the range of from 20 to 90° C., preferably in the range from 40 to 60° C.

The solid content of the dispersion can be in the range typically of from 10 to 60%, preferably in the range from 20 to 50% more preferably in the range from 25 to 50%.

Suitable polyesters for inclusion in the radiation-curable coating compositions used in the process of the invention include polyesters with no radiation-curable, ethylenically unsaturation and polyesters with radiation-curable, ethylenically unsaturation. In case the polyester comprises radiation-curable, ethylenically unsaturation, the polyester preferably has an average weight per radiation-curable, ethylenically unsaturation (WPU), of from 500 to 5000 g/mol.

Preferably, the polyester is prepared by polycondensation of at least the following components:
(AD1) At least one difunctional acid, and
(AD2) At least one difunctional alcohol, and
(AD3) Optionally at least one difunctional acid other than (A2) that contains at least one salt group which is capable to render the polyester dispersible in water,
(AD4) Optionally at least one monofunctional acid,
(AD5) Optionally at least one tri- or higher functional acid, and
(AD6) Optionally at least one tri- or higher functional alcohol, wherein the total amounts of components (AD1) and (AD2) used to prepare the polyester (AD) is from 20 to 100 wt. %, more preferably from 30 to 100 wt. %, and the total amounts of components (AD3), (AD4), (AD5) and (AD6) used to prepare the polyester (AD) is from 0 to 80 wt. %, more preferably from 0 to 70 wt. %.

Examples of difunctional carboxylic acids (AD1) for preparing the polyester include but are not limited to terephthalic acid, isophthalic acid, phthalic acid (anhydride),2,6-naphthalenedicarboxylic acid, 4,4′-oxybisbenzoic acid, 1,4-cyclohexanedicarboxylic acid, hexahydrophthalic acid (anhydride), tetrahydrophthalic acid (anhydride), azelaic acid, sebacic acid, dodecanedioic acid acid, dimer fatty acid, adipic acid, succinic acid (anhydride), fumaric acid, glutaric acid, itaconic acid, pimelic acid, suberic acid, maleic acid (anhydride), malonic acid and any mixture thereof.

Examples of difunctional alcohols (AD2) for preparing the polyester include but are not limited to ethanediol, ethylene glycol, diethylene glycol, triethylene glycol, tetraethylene glycol, polyethylene glycol (Mn=600-4000 g/mol), polyalkylene glycol, 1,2-propanediol, dipropylene glycol, tripropylene glycol, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,8-octanediol, 1,10-decanediol, 1,12-dodecanediol, 2-methyl-1,3-propanediol, 3-methyl-1,5 pentanediol, hydroxypivalic neopentyl glycol ester, tricyclodecane dimethanol or any mixture thereof.

Examples of difunctional carboxylic acids (AD3) that contains at least one salt group which is capable to render the polyester dispersible in water include 5-(sulfo) isophthalic acid salts, such as metal (Na⁺, Li⁺, K⁺, Mg⁺⁺, Ca⁺⁺, Cu⁺⁺, Fe⁺⁺ or Fe⁺⁺⁺) salts and/or ammonium salts. The preferred 5-(sulfo) isophthalic acid salts are 5-(sulfo) isophthalic acid sodium salt and/or 5-(sulfo) isophthalic acid lithium salt.

Examples of tri- or more functional carboxylic acids (AD5) for preparing the polyester include but are not limited to trimellitic acid (anhydride), citric acid (anhydride), pyromellitic acid (anhydride) and mixtures thereof.

Examples for tri- or more functional alcohols (AD6) for preparing the polyester include but are not limited to trimethylolpropane, trimethylolethane, glycerol, pentaerythritol, bis(trimethylolpropane) ether, xylitol, dipentaerythritol, sorbitol, and mixtures thereof

More preferably, the polyester is prepared by polycondensation of at least the following components:
(AD1) At least one difunctional acid comprising terephthalic acid, isophthalic acid, phthalic acid, adipic acid and any mixture thereof, and
(AD2) At least one difunctional alcohol comprising diethylene glycol, ethylene glycol, 1,4-butanediol, 1,3-propanediol, 1,4-cyclohexanedimethanol, neopentyl glycol, 1,5-pentanediol, 1,6-hexanediol and any mixture thereof, and
(AD3) Optionally at least one difunctional acid other than (A2) that contains at least one salt group which is capable to render the polyester dispersible in water and comprising one or more 5-(sulfo) isophthalic acid salts,
(AD4) Optionally at least one monofunctional acid comprising benzoic acid, soybean oil fatty acids, tall oil fatty acids, soybean oil, tall oil and any mixture thereof,
(A5) Optionally at least one tri- or higher functional acid comprising trimellitic anhydride, citric acid and any mixture thereof, and
(A6) Optionally at least one tri- or higher functional alcohol comprising glycerol, trimethylol propane, pentaerythritol and any mixture thereof,
wherein the total amounts of components (AD1) and (AD2) used to prepare the polyester (A) is from 20 to 100 wt. %, more preferably from 30 to 100 wt. %, and the total amounts of components (AD3), (AD4), (AD5) and (AD6) used to prepare the polyester (AD) is from 0 to 80 wt. %, more preferably from 0 to 70 wt. %.

Even more preferably, the polyester is prepared by polycondensation of at least the following components:
(AD1) At least one difunctional acid comprising terephthalic acid, isophthalic acid, phthalic acid, adipic acid and any mixture thereof, and
(AD2) At least one difunctional alcohol comprising diethylene glycol, ethylene glycol, 1,4-butanediol, 1,3-propanediol, 1,4-cyclohexanedimethanol, neopentyl glycol, 1,5-pentanediol, 1,6-hexanediol and any mixture thereof,
(AD3) At least one difunctional acid other than (A2) that contains at least one salt group which is capable to render the polyester dispersible in water, preferably one or more 5-(sulfo) isophthalic acid salt, and
(AD4) Optionally at least one monofunctional acid comprising benzoic acid, soybean oil fatty acids, tall oil fatty acids, soybean oil, tall oil and any mixture thereof,
(AD5) Optionally at least one tri- or higher functional acid comprising trimellitic anhydride, citric acid and any mixture thereof, and
(AD6) Optionally at least one tri- or higher functional alcohol comprising glycerol, trimethylol propane, pentaerythritol and any mixture thereof,
wherein the total amounts of components (AD1) and (AD2) used to prepare the polyester (AD) is from 30 to 99 wt. %, the amount of component (AD3) is from 1 to 10 wt. % and the total amounts of components (AD4), (AD5) and (AD6) used to prepare the polyester (A) is from 0 to 69 wt. %.

### Reactive Diluent(s) (B)

As used herein, a “diluent” means a substance which reduces the viscosity of the greater composition into which it is added or with which it is associated.

As used herein, “reactive” means the ability to form a chemical reaction, preferably a polymerization reaction, with another molecule. As such, a reactive compound will be said to possess at least one reactive, or functional, group. It is preferred that such reactive or functional group is a polymerizable group, more preferred that such reactive or functional group is an ethylenically unsaturated polymerizable group, even more preferred is an acrylate group.

As used herein, the acrylate functionality of a compound is the number of acrylate functional groups per molecule of the compound.

The one or more reactive diluents (also referred to as radiation curable diluents) that are present in the aqueous, radiation curable coating composition preferably have from 1 to 6 acrylate groups, i.e. have an acrylate functionality of from 1 to 6. More preferably, the one or more acrylate functional diluents have an acrylate functionality of from 1 to 5, even more preferably from 1 to 4, even more preferably from 2 to 4. Preferably, at least one of the acrylate functional diluents that are present in the aqueous, radiation curable coating composition has an acrylate functionality of 2 or 3. In a preferred embodiment, the aqueous, radiation curable coating composition comprises at least two reactive diluent monomers with different functionality. The average functionality of the at least two reactive diluent monomers with different functionality is preferably at least 1.1, more preferably at least 1.2, and preferably at most 4, more preferably at most 3. As used herein, the average functionality of at least two reactive diluent monomers with different

$$functionality = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate functional diluent in gram present in the aqueous, radiation curable coating composition with a molar mass Mₖ and with a functionality fₖ.

Preferably, the aqueous, radiation-curable coating composition used in the process of the present comprises monofunctional diluent in an amount less than 50 wt. %, more preferably at less than 30 wt. %, more preferably less than 10 wt. % and more preferably less than 5 wt. %, and especially preferred less than 3 wt. %, relative to the weight of the entire aqueous, radiation-curable coating composition.

The one or more reactive diluents preferably have a molar mass higher than 125 g/mol, more preferably higher than 150 g/mol, more preferably higher than 175 g/mol, even more preferably higher than 200 g/mol and preferably lower than 800 g/mol, more preferably lower than 650 g/mol, more preferably lower than 700 g/mol, even more preferably lower than 650 g/mol. The molar mass is the calculated molar mass obtained by adding the atomic masses of all atoms present in the structural formula of the compound.

Preferably, the one or more reactive diluents are aliphatic reactive diluents, i.e. not containing aromatic groups. Preferred examples of aliphatic reactive diluents are lauryl acrylate, isobornyl acrylate, 1,6-hexane diol diacrylate, neopentyl glycol diacrylate, isodecyl acrylate, diethyleneglycol diacrylate, dipropyleneglycol diacrylate (DPGDA), triethyleneglcyol diacrylate, tripropyleneglcyol diacrylate trimethylolpropane diacrylate, trimethylolpropane triacrylate (TMPTA), di(trimethylolpropane) triacrylate (di-TMP3A), and pentaerythritol tetra-acrylate (PET4A), di(trimethylolpropane) tetra-acrylate (di-TMPTA), glyceryl propoxy triacrylate (GPTA), pentaerythritol tri-acrylate (PET3A).

In a preferred embodiment of the invention, at least 10 wt. %, preferably at least 20 wt. %, more preferably at least 30 wt. % more preferably at least 40 wt. %, more preferably at least 50 wt. %, more preferably at least 60 wt. %, more preferably at least 70 wt. %, more preferably at least 80 wt. %, more preferably at least 90 wt. % and most preferably 100 wt. % of the reactive diluents (B) is selected from the group consisting of:

di(trimethylolpropane) tetra-acrylate (di-TMPTA), di(trimethylolpropane) tri-acrylate (di-TMP3A), glycerol triacrylate, pentaerythritol tetra-acrylate (PET4A), pentaerythritol tri-acrylate (PET3A), trimethylolpropane triacrylate (TMPTA), dipropyleneglycol diacrylate (DPGDA), and their alkoxylated, preferably propoxylated, versions and any mixture thereof.

Preferably, at least one of the reactive diluents (B) has an acrylate functionality of 2 or 3. The reactive diluents (B) with an acrylate functionality of 2 are preferably selected from the group consisting of dipropyleneglycol diacrylate (DPGDA), dipropyleneglycol diacrylate comprising additional alkoxy groups, preferably propoxy groups; and any mixture thereof. The reactive diluents (B) with an acrylate functionality of 3 are preferably selected from the group consisting of glyceryl propoxy triacrylate (GPTA), trimethylolpropane triacrylate (TMPTA), di(trimethylolpropane) tri-acrylate (di-TMP3A), pentaerythritol tri-acrylate (PET3A) and pentaerythritol tri-acrylate, including their alkoxylated versions and any mixture thereof. The reactive diluents (B) with an acrylate functionality of 2 or 3 preferably comprises alkoxy groups, preferably propoxy groups (—C₃H₆O—).

Preferably, the composition further comprises at least one of the reactive diluents (B) with an acrylate functionality of 4 or 5, as this advantageously may result in further improved chemical resistances. The reactive diluents (B) with an acrylate functionality of 4 are preferably selected from the group consisting of di(trimethylolpropane) tetra-acrylate (di-TMPTA), pentaerythritol tetra-acrylate (PET4A), pentaerythritol tetra-acrylate comprising alkoxy groups, preferably propoxy groups; and any mixture thereof.

The reactive diluents (B) with an acrylate functionality of 5 is preferably dipentaerythritol penta-acrylate (DPPA).

In an even more preferred embodiment of the invention, at least 10 wt. %, preferably at least 20 wt. %, more preferably at least 30 wt. % more preferably at least 40 wt. %, most preferably at least 50 wt. %, more preferably at least 60 wt. %, more preferably at least 70 wt. %, more preferably at least 80 wt. %, more preferably at least 90 wt. % and most preferably 100 wt. % of the reactive diluents (B) is a mixture of
(1) di(trimethylolpropane) tetra-acrylate (di-TMPTA) and/or pentaerythritol tetra-acrylate (PET4A) and/or pentaerythritol tetra-acrylate comprising alkoxy groups, and
(2) glyceryl propoxy triacrylate (GPTA) and/or glyceryl propoxy triacrylate comprising additional alkoxy groups, preferably propoxy groups and/or dipropyleneglycol diacrylate (DPGDA) and/or dipropyleneglycol diacrylate comprising additional alkoxy groups, preferably propoxy groups.

The amounts of the one or more polymers and the one or more reactive diluents in the aqueous, radiation-curable coating composition can vary within wide ranges as water and optional organic solvent can be used to adopt the viscosity and to tune the layer thickness of the applied coating. Preferably, the amount of the one or more polymers is from 35 to 80 wt. % and the amount of the one or more reactive diluents is from 20 to 65 wt. %, more preferably the amount of the one or more polymers is from 40 to 80 wt. % and the amount of the one or more reactive diluents is from 20 to 60 wt. %, based on the total amount of the one or more polymers and the one or more reactive diluents.

The summed amount of the one or more polymers and of the one or more reactive diluents is preferably from 10 to 60 wt. %, more preferably from 15 to 50 wt. %, more preferably from 15 to 45 wt. %, even more preferably from 20 to 40 wt. %, even more preferably from 25 to 35 wt. %, based on the entire weight of the aqueous, radiation-curable coating composition.

The optional organic solvent is present in an amount of at most 30 wt. %, preferably at most 25 wt. %, more preferably at most 20 wt. %, more preferably in an amount of at most 15 wt. %, more preferably in an amount of at most 10 wt. %, more preferably in an amount of at most 5 wt. %, more preferably in an amount of at most 1 wt. %, wherein the amount of organic solvent is given based on the total amount of water and organic solvent present in the aqueous, radiation-curable coating composition. Suitable organic solvents are solvents which are inert in respect of the functional groups present in the coating composition. Suitable solvents are for example hydrocarbons, alcohols, ketones and esters, such as co-solvents also having the function of coalescent such as 1-methyl-2-pyrrolidinone, glycols and glycol ethers such as butyldiglycol, dipropylene glycol methyl ether, acetone, methyl ethyl ketone and alkyl ethers of glycol acetates or mixtures thereof. Most preferably the aqueous, radiation-curable coating composition is essentially free of organic solvent, i.e. organic solvent is preferably not deliberately be added (i.e. small amounts of organic solvent may be present in the additives used to prepare the composition) to the aqueous, radiation-curable coating composition.

The viscosity of the dispersion consisting of (A), (B) and (C) and containing from 10 to 60 wt. % of (A) and (B), relative to the total amount of (A), (B) and (C), is preferably from 10 to 1000 mPa·s, or from 10 to 800 mPa·s, or from 10 to 500 mPa·s.

The z-average particle size of the dispersion consisting of (A), (B) and (C) is preferably from 20 to 1000 nm, more preferably from 25 to 500 nm, even more preferably from 25 to 250 nm and most preferably from 30 to 200 nm.

The aqueous, radiation curable coating composition used in the present invention preferably comprises a photoinitiation system that comprises (i) at least one compound that comprises at least one photoredox active group (also referred to as photoredox active compound) and (ii) at least one compound that comprises at least one redox active group (also referred to as redox active compound). In an embodiment of the invention, the photoredox active group(s) and the redox active group(s) are present in the same molecule. In another and preferred embodiment, the photoredox active group(s) and the redox active group(s) are present in separate molecules. In another preferred embodiment, a part of the photoredox active groups and a part of the redox active groups are present in the same molecule and the remaining part of the photoredox active groups and the remaining part of the redox active groups are present in separate molecules.

With a photoredox active compound is meant a compound which generates an excited state after absorbing light in the 231 to 280 nm wavelength range and when in the excited state it is able to oxidize or reduce a redox active compound.

With a redox active compound is meant a compound which is able to be oxidized or reduced by the excited state of a photoredox active compound.

Without wishing to be bound by any theory, the inventors hypothesize that upon irradiation with light in the 231 to 280 nm wavelength region, a π-π* transition might take place in the photoredox active compound. This short lived excited state might now undergo a redox reaction with the redox active compound (which reaction can be described by the Rehm Weller equation) to yield one or more initiating radicals depending on the photoredox active compound and the redox active compound. Due to the low penetration depth of light in the 231 to 280 nm wavelength region, these radicals will only be formed at the surface leading to a partially cured thin skin and subsequently diffusion of monomers into the thin skin generating micro-folding resulting in the lowering of the gloss. For the finish cure step (4) or the optional pre-cure step (2a), in which the irradiating is performed with light having substantial emission at wavelengths >280 nm, it is speculated that now a n-π* transition might take place. These longer lived excited state might generate initiating radicals via α-cleavage reactions, hydrogen abstraction reactions and via redox reactions. Due to the higher penetration depth of the light employed, this might result in radicals formed over the entire depth of the coating resulting in at least a partial (pre-cure) or full cure of the coating. In case of finish cure via E beam, initiating radicals are generated by the interaction of the accelerated electrons with the material over the entire depth of the coating.

The one or more photoredox active compounds preferably have a peak absorbance in the wavelength range from 231 to 280 nm, more preferably in the wavelength range from 241 to 280 nm, even more preferably in the wavelength range from 241 to 270 nm, even more preferably in the wavelength range from 244 to 265 nm, or preferably in the wavelength range from 251 to 280 nm, more preferably in the range from 251 to 260 nm. Examples of suitable photoredox active compounds are onium salts, like for example iodonium and sulphonium salts; and/or organometallic compounds like metallocene compounds, for example titanocene compounds; and/or compounds comprising at least one aryl ketone moiety, such as aromatic ketones and/or aromatic α-hydroxyketones; and/or keto esters. Preferred photoredox active compounds are compounds comprising at least one (preferably one or two) aryl ketone moiety with the following structural formula (1), whereby the aromatic ring may be optionally substituted with one or more C1-C9 hydrocarbon groups (preferably C1-C9 alkyl groups), one or more halogenide, one or more ether groups and/or one or more ester groups.

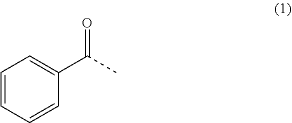

In the embodiments of the invention in which at least part of the photoredox active groups and at least part of the redox active groups are present in the same molecule, the aryl ketone moiety is for example substituted with a thioether or a dialkylamino group, for example (H₃C)₂—N—.

More preferred photoredox active compounds are aromatic ketones and aromatic α-hydroxy ketones since these with strong absorption at π-π* transition facilitate obtaining very thin skin layer easily forming microfold giving very low gloss levels. Examples of (substituted) aromatic ketones are benzophenone, methyl 2-benzoyl benzoate (CAS No 606-28-0), 4-methyl benzophenone (CAS No 134-84-9). Examples of aromatic α-hydroxy ketones are Omnirad 1173 (CAS No. 7473-98-5) and Omnirad 127 (CAS No 474510-57-1).

Suitable redox active compounds are preferably selected from the group consisting of aliphatic amines, aromatic amines, thioethers, thiols and any mixture thereof. For reasons of stability, the amine is preferably a tertiary amine as otherwise they can undergo Michael addition reactions with the radiation curable groups present in the radiation curable coating composition thereby forming a tertiary amine. More preferably, the one or more redox active compounds are aliphatic tertiary amines. Preferably, the redox active compound is acrylate functional, i.e. contains one, preferably two or more acrylate groups. Without wishing to be bound by any theory, the inventors speculate that upon reaction of the acrylate groups of the acrylate functional redox active compound in the skin layer of the coating, diffusion of this compound from the lower layers takes places, thereby enhancing the active concentration of redox active compound in the skin. Examples of suitable acrylate functional amines are Agisyn™ 002 (acrylate functionality is 1), Agisyn™ 008 (acrylate functionality is 2), both can also act as reactive diluents, Agisyn™ 701 and Agisyn™ 703 (acrylate functionality is 4), both can also act as acrylate functional oligomers, available from Covestro AG. Examples of suitable acrylate functional thioethers are BDT-1006, BDT-1015, BDT-4330 and XDT-1018, available from Bomar. Acrylate functionality of the redox active compound is believed to benefit the surface properties of the final cured coating, such as stain resistance and abrasion resistance. Most preferred redox active compounds are aliphatic tertiary amines having at least one acrylate functional group, preferably two or more acrylate functional groups.

When UV irradiation is applied in the finish-cure step (4), the photoinitiation system optionally further comprises next to the photoredox active compound another photoactive compound. With a photoactive compound is meant a compound which upon irradiation with light substantially having wavelengths >280 nm is able to generate radicals. Examples of suitable photoactive compounds, including examples of suitable photoredox active compounds, include, but are not limited to, bisacylphosphine oxides, such as for example bis(2,4,6-trimethylbenzoyl)-phenylphosphine oxide (CAS #162881-26-7) or is bis(2,4,6-trimethylbenzoyl)-(2,4-bis-pentyloxyphenyl)phosphine oxide; monoacylphosphine oxide, such as for example 2,4,6-trimethylbenzoylethoxyphenylphosphine oxide (CAS #84434-11-7) or 2,4,6-trimethylbenzoyldiphenylphosphine oxide (CAS #127090-72-6); ketals such as 2,2-dimethoxy-1,2-diphenylethan-1-one (CAS #24650-42-8); benzophenones such as benzophenone, 2,4,6-trimethylbenzophenone, 4-methylbenzophenone, 2-methylbenzophenone, 2-methoxycarbonylbenzophenone, 4-phenylbenzophenone, 4,4′-bis(dimethylamino)-benzophenone, 4,4′-bis(diethylamino)benzophenone, methyl2-benzoylbenzoate, 3,3′-dimethyl-4-methoxybenzophenone, 4-(4-methylphenylthio)benzophenone, 2,4,6-trimethyl-4′-phenyl-benzophenone or 3-methyl-4′-phenyl-benzophenone; α-hydroxy ketones such as α-hydroxycyclohexyl phenyl ketone, 2-hydroxy-2-methyl-1-phenylpropanone, 2-hydroxy-2-methyl-1-(4-isopropylphenyl) propanone, 2-hydroxy-2-methyl-1-(4-dodecylphenyl) propanone, 2-Hydroxy-1-{4-[4-(2-hydroxy-2-methyl-propionyl)-benzyl]-phenyl}-2-methyl-propan-1-one and 2-hydroxy-2-methyl-1-[(2-hydroxyethoxy)phenyl]propanone; α-aminoketones, such as 2-methyl-1-[4-(methylthio)phenyl]-2-(4-morpholinyl)-1-propanone, 2-benzyl-2-(dimethylamino)-1-[4-(4-morpholinyl)phenyl]-1-butanone, 2-(4-methylbenzyl-2-(dimethylamino)-1-[4-(4-morpholinyl)phenyl]-1-butanone or 2-benzyl-2-(dimethylamino)-1-[3,4-dimethoxyphenyl]-1-butanone; ketal compounds, for example 2,2-dimethoxy-1,2-diphenyl-ethanone; and monomeric or dimeric phenylglyoxylic acid esters, such as methylphenylglyoxylic acid ester, 5,5′-oxo-di(ethyleneoxydicarbonylphenyl) or 1,2-(benzoylcarboxy)ethane; oxime esters, such as those disclosed in U.S. Pat. No. 6,596,445; phenyl glyoxalates, for example those disclosed in U.S. Pat. No. 6,048,660.

In case the finish cure is performed by irradiation with light substantially having wavelengths >280 nm, it is preferred that the photoinitiation system is also capable of generating radicals when irradiated with light having wavelengths >280 nm. Preferably the photoredox active compound and the redox active compound are also capable of generating radicals when irradiated with light having wavelengths >280 nm.

The photoinitiation system is preferably present in the aqueous, radiation curable coating composition in an amount of at least 5 wt. %, more preferably of at least 7.5 wt. % and even more preferably of at least 10 wt. %, and preferably in an amount of at most 45 wt. %, more preferably of at most 30 wt. % and more preferably of at most 20 wt. %, whereby the amount is given relative to the aqueous, radiation curable coating composition. Preferably, the one or more photoredox active compounds and the redox active compounds are present in the aqueous, radiation curable coating composition in such an amount that the ratio of the molar amount of the photoredox active groups to the molar amount of the redox active groups is from 1:4 to 4:1, more preferably from 1:3 to 3:1, even more preferably from 1:2 to 2:1. In case a photoredox active compound is used which contains more than one photoredox active groups, the molar amount of the photoredox active groups is calculated by multiplying the molar amount of the photoredox active compound that is present in the aqueous, radiation curable coating composition with the number of photoredox active groups present in the photoredox active compound. Similar, in case a redox active compound is used which contains more than one redox active groups, the molar amount of the redox active groups is calculated by multiplying the molar amount of the redox active compound that is present in the aqueous, radiation curable coating composition with the number of redox active groups present in the redox active compound. For example, when pentaerytritol tetra mercaptopropionate is used as redox active compound, the molar amount of the redox active groups is calculated by multiplying the molar amount of pentaerytritol tetra mercaptopropionate that is present in the aqueous, radiation curable coating composition with 4, i.e. the number of thiol groups present in pentaerytritol tetra mercaptopropionate.

In the embodiment in which the photoredox active groups and the redox active groups are present in separate molecules, the one or more photoredox active compounds are preferably present in the aqueous, radiation curable coating composition in an amount of at least 1 wt. %, more preferably of at least 2 wt. %, even more preferably of at least 3 wt. %, even more preferably of at least 4 wt. %, even more preferably of at least 5 wt. % and preferably in an amount of at most 15 wt. %, more preferably of at most 12 wt. %, even more preferably of at most 10 wt. %, even more preferably of at most 9 wt. %, whereby the amount is given relative to the aqueous, radiation curable coating composition; and/or the one or more redox active compounds are preferably present in the aqueous, radiation curable coating composition in an amount of at least 1 wt. %, more preferably of at least 2 wt. %, even more preferably of at least 3 wt. %, even more preferably of at least 4 wt. %, even more preferably of at least 5 wt. %, and preferably in an amount of at most 30 wt. %, more preferably at most 25 wt. %, even more preferably at most 20 wt. %, even more preferably at most 15 wt. %, whereby the amount is given relative to the aqueous, radiation curable coating composition. In case the redox active compound is acrylate functional (and thus may also act as reactive diluent or as reactive oligomer), the upper limit of the amount of redox active compounds can be very high. For example both reactive diluent and oligomer in the radiation curable coating composition can be amine functional and thus redox active. In this case the amount of redox active compounds can be as high as 95%. As used herein, reactive diluent comprising redox active groups and oligomer comprising redox active groups are considered herein as redox active compounds. Accordingly, the amount of reactive diluent comprising redox active groups and the amount of oligomer comprising redox active groups are included in the determination of amount of redox active compounds; the amount of reactive diluent comprising redox active groups is not to be included in the determination of the amount of reactive diluent; and the amount of oligomer comprising redox active groups is not to be included in the determination of the amount of oligomer. In case the redox active compound is acrylate functional, the amount of the redox active compounds in the aqueous, radiation curable coating composition is preferably also at most 30 wt. %, more preferably at most 25 wt. %, even more preferably at most 20 wt. %, even more preferably at most 15 wt. %, even more preferably at most 20 wt. %, even more preferably at most 10 wt. %.

The aqueous radiation curable coating composition usually further contain an additive compound; that is, a collection of one or more than one individual additives having one or more than one specified structure or type. Suitable additives are for example light stabilizers, such as UV absorbers and reversible free-radical scavengers (HALS), antioxidants, degassing agents, wetting agents, emulsifiers, slip additives, waxes, polymerisation inhibitors, adhesion promoters, flow control agents, film-forming agents, rheological aids such as thickeners, flame retardants, corrosion inhibitors, waxes, driers and biocides. One or more of the aforementioned additives can be employed in the coating composition used in the process of the present invention in any suitable amount and may be chosen singly or in combination of one or more of the types enumerated herein. In a preferred embodiment, the additive compound is present in an amount, relative to the entire weight of the coating composition, of from about from 0 wt. % to 20 wt. %, or from 0 wt. % to 10 wt. %, or from 0 wt. % to 5 wt. %; or from 0.01 wt. % to 20 wt. %, or from 0.01 wt. % to 10 wt. %, or from 0.01 wt. % to 5 wt. %, or from 0.1 wt. % to 2 wt. %. According to another embodiment, the additive compound is present, relative to the weight of the entire radiation curable composition, from 1 wt. % to 20 wt. %, or from 1 wt. % to 10 wt. %, or from 1 wt. % to 5 wt. %. The coating composition can also be pigmented. The coating composition then contain at least one pigment. Preferably the coating composition does not contain any pigments. The coating composition can also contain one or more inorganic fillers.

The coating composition can also contain matting agents which have an additional matting effect. Suitable matting agents are for example silicon dioxides. The amount of matting agents, if included, is typical in the range of from 0.1 to 10 wt. %, in particular in the range of from 0.5 to 5 wt. %, based on the total weight of the radiation-curable compounds in the coating composition.

The present invention further relates to the aqueous, radiation curable coating composition as described herein above.

The present invention further relates to a low gloss coated substrate that is obtained by coating a substrate, preferably a plastic, paper or metal substrate or a substrate of a combination of any of plastic, paper and metal with the method as described herein above. Suitable substrates for the process according to the invention are for example mineral substrates such as fiber cement board, wood, wood containing materials, paper including cardboard, textile, leather, metal, thermoplastic polymer, thermosets, ceramic, glass. Suitable thermoplastic polymers are for example polyvinylchloride PVC, polymethylmethacrylate PMMA, acrylonitrile-butadiene-styrene ABS, polycarbonate, polypropylene PP, polyethylene PE, polyamide PA and polystyrene. Suitable thermosets are for example linoleum, epoxy, melamine, novolac, polyesters and urea-formaldehyde. The substrate is optionally pre-treated and/or optionally pre-coated. For example, thermoplastic plastic films can be treated with corona discharges before application or pre-coated with a primer. Mineral building materials are also usually provided with a primer before the coating composition is applied.

The coating obtained in the process of the invention can advantageously be used in a floor or wall covering or in automotive interior or on furniture or on window frames or on façade panels. With the process of the invention, low gloss coatings can advantageously be obtained with a dry thickness of at least 1 micron, or of at least 2 micron, or of at least 3 micron, or of at least 4 micron, and of at most 100 micron, or of at most 75 micron, or of at most 50 micron.

The invention is further defined by the set of exemplary embodiments as listed hereafter. Any one of the embodiments, aspects and preferred features or ranges as disclosed in this application may be combined in any combination, unless otherwise stated herein or if technically clearly not feasible to a skilled person.

[1] A method for producing a cured coating with a low gloss surface from an aqueous, radiation curable coating composition, wherein the method comprises the following steps:
(1) applying an aqueous, radiation curable coating composition on a substrate,
(2) drying the aqueous, radiation curable coating composition, affording an at least partially dried coating composition,
(3) irradiating the at least partially dried coating composition from step (2) with UV light having wavelengths essentially in the range from 231 to 280 nm, affording a coating with a partially cured surface layer with reduced gloss, followed by
(4) finish curing the coating from step (3) with actinic radiation, thereby fixating the partially cured surface layer with reduced gloss and affording the cured coating with the low gloss surface,
wherein step (3) and step (4) are performed in air; and
wherein the aqueous, radiation curable coating composition comprises at least one polymer, at least one reactive diluent, and water.

[2] The method according to embodiment [1], wherein the irradiating in step (3) is carried out with UV light having wavelengths essentially in the range from 241 to 280 nm, preferably in the range from 241 to 270 nm, more preferably in the range from 244 to 265 nm, or in the range from 251 to 280 nm, preferably in the range from 251 to 260 nm.

[3] The method according to embodiment [1] or [2], wherein UV light having wavelengths essentially in the wavelength range from X to Y means that at least 60%, preferably at least 70%, even more preferably at least 80% of the actinic radiation power of the applied radiation source is provided by UV light in the wavelength range of from X to Y.

[4] The method according to any of the preceding embodiments, wherein the UV light applied in step (3) has a UV radiation dose in the range from 2 to 200 mJ/cm², preferably has a radiation dose of at least 3 mJ/cm², or of at least 4 mJ/cm², or of at least 5 mJ/cm², and preferably has a radiation dose at most 90 mJ/cm², preferably of at most 90 mJ/cm², more preferably of at most 80 mJ/cm², or of at most 70 mJ/cm², or of at most 60 mJ/cm², or of at most 50 mJ/cm², or of at most 40 mJ/cm².

[5] The method according to any of the preceding embodiments, wherein the skin cure step is performed with one or more lamp units, whereby the irradiance from each lamp unit in the skin cure step (3) is at least 5 mW/cm², more preferably at least 10 mW/cm², even more preferably at least 15 mW/cm², even more preferably at least 20 mW/cm², even more preferably at least 25 mW/cm², even more preferably at least 30 mW/cm²; and the irradiance from each lamp unit in the skin cure step (2) is preferably at most 500 mW/cm², more preferably at most 300 mW/cm², even more preferably at most 200 mW/cm².

[6] The method according to any of the preceding embodiments, wherein the UV light applied in step (3) is from 1 lamp, or 2 lamps, or 3 lamps, or 4 lamps, or 5 lamps, or at most 6 lamps, and these lamps can be in one or multiple lamp units.

[7] The method according to any of the preceding embodiments, wherein the irradiating in step (3) is carried out with a low pressure mercury vapor lamp, or with an UVC LED lamp with peak wavelength in the range of from 231 to 280 nm, or with an Excimer lamp with peak wavelength of from 231 to 280 nm, or with a medium pressure mercury vapor lamp in combination with an optical bandpass filter with maximum transmission in the wavelength range of from 241 nm to 270 nm, preferably in the wavelength range of from 251 to 260 nm.

[8] The method according to any of the preceding embodiments, wherein the irradiating in the finish curing step (4) is carried out with E-beam or with light having substantial emission at wavelengths higher than 280 nm, preferably with UV light of which at least 40% of the actinic radiation power of the applied radiation source is provided by light having wavelengths higher than 280 nm.

[9] The method according to any of the preceding embodiments, wherein at most 10%, more preferably at most 5%, even more preferably at most 2%, even more preferably at most 1%, even more preferably 0% of the radiation power of the applied radiation source in step (3) emits light at wavelengths≤230 nm; and/or wherein also of the radiation power of the applied radiation source in step (3) that is emitted in the wavelength range from 200 to 390 nm, at least 60%, more preferably at least 70%, even more preferably at least 80% is in the wavelength range from 231 to 280 nm, preferably in the range from 241 to 270 nm, more preferably in the range from 244 to 265 nm, or preferably in the range from 251 to 280 nm, more preferably in the range from 251 to 260 nm, and wherein preferably also of the radiation power of the applied radiation source in step (3) that is emitted in the wavelength range from 231 to 390 nm, at least 70%, more preferably at least 80%, even more preferably at least 90% is in the wavelength range from 231 to 280 nm, more preferably in the range from 241 to 270 nm, even more preferably in the range from 244 to 265 nm, or preferably in the range from 251 to 280 nm, more preferably in the range from 251 to 260 nm.

[10] The method according to any of the preceding embodiments, wherein the light applied in step (4) has a radiation dose in the range from 150 to 2500 mJ/cm², preferably has a radiation dose of at least 200 mJ/cm², or of at least 250 mJ/cm², or at least 300 mJ/cm², and preferably has a radiation dose of at most 2250 mJ/cm², or of at most 2000 mJ/cm².

[11] The method according to any of the preceding embodiments, wherein the irradiating in step (4) is carried out with a broad band UV lamp.

[12] The method according to any one of the preceding embodiments, wherein the method comprises the following steps:
(1) applying an aqueous, radiation curable coating composition on a substrate,
(2) drying the aqueous, radiation curable coating composition, affording an at least partially dried coating composition,
(2a) optionally pre-curing the radiation curable coating composition from step (2) by irradiating with light, affording a partially cured coating,
(3) irradiating the at least partially dried coating composition from step (2) or the partially cured coating from step (2a), when present, with UV light having wavelengths essentially in the range from 231 to 280 nm, affording a coating with a partially cured surface layer with reduced gloss,
followed by
(4) finish curing the coating from step (3) with actinic radiation, thereby fixating the partially cured surface layer with reduced gloss and affording the cured coating with the low gloss surface, and
wherein step (3) and step (4) are performed in air.

[13] The method according to embodiment [12], wherein the irradiating in step (2a), when present, is carried out with light having substantial emission at wavelengths higher than 280 nm, preferably with light of which at least 40% of the actinic radiation power of the applied radiation source is provided by light having wavelengths higher than 280 nm, more preferably with light of which at least 40%, more preferably at least 60%, more preferably at least 80%, more preferably 100% of the actinic radiation power of the applied radiation source is provided by light having wavelengths higher than 320 nm.

[14] The method according to embodiment or [13], wherein the light applied in step (2a), when present, has a radiation dose in the range from 1 to 200 mJ/cm², preferably has a radiation dose of at least 2 mJ/cm², or of at least 3 mJ/cm², and preferably has a radiation dose of at most 90 mJ/cm², or of at most 80 mJ/cm², or of at most 70 mJ/cm², or of at most 60 mJ/cm², or of at most 50 mJ/cm², or of at most 40 mJ/cm², or of at most 30 mJ/cm², or of at most 20 mJ/cm².

[15] The method according to any one of embodiments to [14], wherein the irradiating in step (2a), when present, is carried out with a LED lamp with peak wavelength in the range from 350 to 450 nm.

[16] The method according to any one of embodiments to [15], wherein step (2a), when present, is performed in air.

[17] The method according to any one of the preceding embodiments, wherein a microfold pattern is formed at the coating surface after step (3), having a random microscopic pattern of peaks and valleys with average spacing between adjacent peaks and/or or valleys shorter than 100 μm, preferably shorter than 80 μm, more preferably shorter than 60 μm.

[18] The method according to any one of the preceding embodiments, wherein the at least one polymer present in the aqueous, radiation curable coating composition is selected from the group consisting of polyurethane, radiation curable polyurethane, vinyl polymer, polyester, polyurethane-vinyl polymer hybrid, and any mixture thereof.

[19] The method according to any one of the preceding embodiments, wherein the aqueous, radiation curable coating composition is a dispersion comprising:
(A) Particles comprising at least one water-dispersed polymer, preferably selected from the group consisting of polyurethane, radiation curable polyurethane, vinyl polymer, polyester, polyurethane-vinyl polymer hybrid, and any mixture thereof and
(B) At least one radiation curable diluent (B) with a molar mass less than 800 g/mol and with an acrylate functionality of from 1 to 6, and
(C) Water and optionally organic solvent, whereby the optional organic solvent is present in an amount of at most 30 wt. %, based on the total amount of water and organic solvent,
wherein the amount of (A) is from 30 to 95 wt. % and the amount of (B) is from 5 to 70 wt. %, based on the total amount of (A) and (B).

[20] The method according to embodiment [19], wherein the aqueous, radiation curable coating composition comprises dispersed particles of polyurethane (AA), wherein the the polyurethane (AA) is optionally radiation curable.

[21] The method according to embodiment [20], wherein the urea group (—NH—CO—NH—) concentration of the polyurethane (AA) is preferably at most 2.6 milli-equivalents per g of polyurethane (AA), preferably of at most 1.3 meq per g of (AA) and preferably of at least 0.05 meq per g of (AA), more preferably of at least 0.2 meq per g of (AA); and/or the weight-average molecular weight M_{w} of the polyurethane (AA) is at least 15,000 g/mol, more preferably at least 20,000 g/mol, even more preferably at least 30,000 g/mol determined with size exclusion chromatography.

[22] The method according to embodiment [20] or [21], wherein the polyurethane (AA) is preferably prepared from the reaction of at least the following components:
(AA1) At least one polyisocyanate,
(AA2) At least one isocyanate-reactive compound that contains at least one salt group which is capable to render the polyurethane (AA) dispersible in water and/or a functional group that can be converted into a salt group which is capable to render the polyurethane (A) dispersible in water,
(AA3) Optionally at least one isocyanate-reactive compound containing at least one non-ionic group which is capable to render the polyurethane (AA) dispersible in water,
(AA4) Optionally at least one isocyanate-reactive compound containing radiation-curable ethylenically unsaturated groups,
(AA5) At least one isocyanate-reactive polyol other than (AA2), (AA3) and (AA4) with an OH number of from 25 to 225 mg KOH/g solids,
(AA6) Optionally at least one isocyanate-reactive polyol other than (AA2), (AA3) and (AA4) having an OH number of higher than 225 mg KOH/g solids and lower than 1850 mg KOH/g solids, and
(AA7) Water and/or at least one nitrogen containing chain extender compound,
wherein the isocyanate-reactive group is preferably a hydroxyl group.

[23] The method according to any one of embodiments [20]-[22], wherein the aqueous, radiation curable coating composition comprises dispersed particles of a vinyl polymer system (AB), wherein the vinyl polymer system (AB) is essentially free of radiation-curable, ethylenically unsaturated bonds and wherein the vinyl polymer system (AB) preferably comprises one or more vinyl polymers with preferably a glass transition temperature T_{g} of less than or equal to 77° C. in an amount of at least 50 wt. %, preferably at least 65 wt. %, based on the amount of the polymer system (AB).

[24] The method according to embodiment [23], wherein the vinyl polymer system (AB) present in the aqueous, radiation-curable coating composition to be used in the present invention preferably has a theoretical acid value from 5 to 105 mg KOH/gram (AB) and/or the vinyl polymer system (AB) preferably has a weight-average molecular weight M_{w} of at least 5,000 g/mol, more preferably of at least 10,000 g/mol, even more preferably at least 20,000 g/mol, even more preferably at least 30,000 g/mol and preferably of at most 1,000,000 g/mol, more preferably of at most 500,000 g/mol, even more preferably at most 250,000 g/mol, wherein the weight-average molecular weight M_{w} is determined by size exclusion chromatography (SEC).

[25] The method according to any one of embodiments [19]-[24], wherein the aqueous, radiation curable coating composition comprises at least one hybrid (AC) of at least one polyurethane and at least one vinyl polymer obtained by free-radical polymerization of one or more vinyl monomers in the presence of at least one polyurethane, preferably in the presence of at least one water-dispersed polyurethane.

[26] The method according to embodiment [25], wherein the polyurethane (AC-PU) of the hybrid (AC) is prepared from the reaction of at least the following components:
(AA1) At least one polyisocyanate,
(AA2) At least one isocyanate-reactive compound that contains at least one salt group which is capable to render the polyurethane dispersible in water and/or a functional group that can be converted into a salt group which is capable to render the polyurethane dispersible in water, preferably acid functional,
(AA3) Optionally at least one isocyanate-reactive compound containing at least one non-ionic group which is capable to render the polyurethane dispersible in water,
(AA5) At least one isocyanate-reactive polyol other than (AA2) and (AA3) having an OH number of from 25 to 225 mg KOH/g solids,
(AA6) Optionally at least one isocyanate-reactive polyol other than (AA2) and (AA3) having an OH number higher than 225 mg KOH/g solids and lower than 1850 mg KOH/g solids, and
(AA7) Water and/or at least one nitrogen containing chain extender compound, wherein the isocyanate-reactive group is preferably a hydroxyl group.

[27] The method according to any one of embodiments [19]-[26], wherein the aqueous, radiation curable coating composition comprises dispersed particles of polyester (AD), wherein the polyester has a glass transition temperature T_{g}, determined using Differential Scanning, of less than or equal to 70° C. and preferably of at least −50° C., more preferably of at least −10° C.; and/or the polyester has an acid value AV of less than or equal to 100 mg KOH/g of the polyester (AD), preferably of at most 70 mg KOH/g of the polyester (AD) and preferably of at least 0.2 mg KOH/g of the polyester (AD), more preferably of at least 0.5 mg KOH/g of the polyester (AD); and/or the polyester (AD) has a number average molecular weight Mₙ, determined using Size Exclusion Chromatography (SEC), of at at least 1000 g/mol, preferably at least 2500 g/mol, and preferably of at most 15000 g/mol, more preferably, more preferably of at most 11000 g/mol.

[28] The method according to embodiment [27], wherein the polyester is prepared by polycondensation of at least the following components:
(AD1) At least one difunctional acid, and
(AD2) At least one difunctional alcohol, and
(AD3) Optionally at least one difunctional acid other than (A2) that contains at least one salt group which is capable to render the polyester dispersible in water,
(AD4) Optionally at least one monofunctional acid,
(AD5) Optionally at least one tri- or higher functional acid, and
(AD6) Optionally at least one tri- or higher functional alcohol,
wherein the total amounts of components (AD1) and (AD2) used to prepare the polyester (AD) is from 20 to 100 wt. %, more preferably from 30 to 100 wt. %, and the total amounts of components (AD3), (AD4), (AD5) and (AD6) used to prepare the polyester (AD) is from 0 to 80 wt. %, more preferably from 0 to 70 wt. %.

[29] The method according to any one of the preceding embodiments, wherein the at least one reactive diluent has a molar mass higher than 125 g/mol, more preferably higher than 150 g/mol, more preferably higher than 175 g/mol, even more preferably higher than 200 g/mol and preferably lower than 800 g/mol, more preferably lower than 750 g/mol, even more preferably lower than 700 g/mol, even more preferably lower than 650 g/mol.

[30] The method according to any one of the preceding embodiments, wherein the at least one reactive diluent is an acrylate functional diluent with an acrylate functionality of from 1 to 6, more preferably from 1 to 4, even more preferably from 2 to 4.

[31] The method according to any one of the preceding embodiments, wherein at least one of the reactive diluents has an acrylate functionality of 2 or 3, wherein the acrylate functional diluents with acrylate functionality of 2 are preferably selected from the group consisting of dipropyleneglycol diacrylate (DPGDA), dipropyleneglycol diacrylate comprising additional alkoxy groups, preferably propoxy groups, and any mixture thereof, and the acrylate functional diluents with acrylate functionality of 3 are preferably selected from the group consisting of glyceryl propoxy triacrylate (GPTA), trimethylolpropane triacrylate (TMPTA), di(trimethylolpropane) tri-acrylate (di-TMP3A), pentaerythritol tri-acrylate (PET3A) and pentaerythritol tri-acrylate, including their alkoxylated versions, and any mixture thereof; and/or the amount of monofunctional diluent present in the radiation curable coating composition is less than 50 wt. %, more preferably at less than 30 wt. %, more preferably less than 10 wt. % and more preferably less than 5 wt. %, and especially preferred less than 3 wt. %, relative to the weight of the entire aqueous, radiation curable coating composition.

[32] The method according to any one of the preceding embodiments, wherein the aqueous, radiation curable coating composition comprises at least two reactive diluent monomers with different acrylate functionality, wherein the average functionality of the at least two reactive diluent monomers with different functionality is preferably at least 1.1, more preferably at least 1.2, and preferably at most 4, more preferably at most 3, whereby the average functionality of at least two reactive diluent monomers with different

$$functionality = \overline{f} = \frac{{\sum }_{k} \frac{{w}_{k}}{{M}_{k}} {f}_{k}}{{\sum }_{k} \frac{{w}_{k}}{{M}_{k}}} ,$$

in which wₖ is the amount of acrylate functional diluent in gram present in the aqueous, radiation curable coating composition with a molar mass Mₖ and with a functionality fₖ.

[33] The method according to any one of the preceding embodiments, wherein at least 10 wt. %, preferably at least 20 wt. %, more preferably at least 30 wt. % more preferably at least 40 wt. %, more preferably at least 50 wt. %, more preferably at least 60 wt. %, more preferably at least 70 wt. %, more preferably at least 80 wt. %, more preferably at least 90 wt. % and most preferably 100 wt. % of the reactive diluents (B) is selected from the group consisting of:
di(trimethylolpropane) tetra-acrylate (di-TMPTA), di(trimethylolpropane) tri-acrylate (di-TMP3A), glycerol triacrylate, pentaerythritol tetra-acrylate (PET4A), pentaerythritol tri-acrylate (PET3A), trimethylolpropane triacrylate (TMPTA), dipropyleneglycol diacrylate (DPGDA), and their alkoxylated, preferably propoxylated, versions and any mixture thereof.

[34] The method according to any one of the preceding embodiments, wherein at least 10 wt. %, preferably at least 20 wt. %, more preferably at least 30 wt. % more preferably at least 40 wt. %, most preferably at least 50 wt. %, more preferably at least 60 wt. %, more preferably at least 70 wt. %, more preferably at least 80 wt. %, more preferably at least 90 wt. % and most preferably 100 wt. % of the reactive diluents (B) is a mixture of
(1) di(trimethylolpropane) tetra-acrylate (di-TMPTA) and/or pentaerythritol tetra-acrylate (PET4A) and/or pentaerythritol tetra-acrylate comprising alkoxy groups,
and
(2) glyceryl propoxy triacrylate (GPTA) and/or glyceryl propoxy triacrylate comprising additional alkoxy groups, preferably propoxy groups and/or dipropyleneglycol diacrylate (DPGDA) and/or dipropyleneglycol diacrylate comprising additional alkoxy groups, preferably propoxy groups.

[35] The method according to any one of the preceding embodiments, wherein the summed amount of the at least one polymer and of the at least one reactive diluent is at least 10 wt. %, more preferably at least 15 wt. %, even more preferably at least 20 wt. %, even more preferably at least 25 wt. %, and preferably at most 60 wt. %, more preferably at most 50 wt. %, more preferably at most 45 wt. %, even more preferably at most 40 wt. %, even more preferably at most 35 wt. %, based on the entire weight of the aqueous, radiation-curable coating composition; and/or the amount of water is at least 5 wt. %, or at least 10 wt. %, or at least 15 wt. %, or at least 20 wt. %, or at least 30 wt. %, or at least 35 wt. %, or at least 40 wt. %, or at least 45 wt. %, or at least 50 wt. %, or at least 55 wt. %, or at least 60 wt. %, and preferably at most 85 wt. %, more preferably at most 75 wt. %, based on the entire weight of the aqueous, radiation curable composition, whereby the optional organic solvent is present in an amount of at most 30 wt. %, preferably at most 25 wt. %, more preferably at most 20 wt. %, more preferably in an amount of at most 15 wt. %, more preferably in an amount of at most 10 wt. %, more preferably in an amount of at most 5 wt. %, more preferably in an amount of at most 1 wt. %, wherein the amount of organic solvent is given based on the total amount of water and organic solvent present in the aqueous, radiation-curable coating composition.

[36] The method according to any one of the preceding embodiments, wherein the amount of the one or more polymers is from 35 to 80 wt. % and the amount of the one or more reactive diluents is from 20 to 65 wt. %, more preferably the amount of the one or more polymers is from 40 to 80 wt. % and the amount of the one or more reactive diluents is from 20 to 60 wt. %, based on the total amount of the one or more polymers and the one or more reactive diluents.

[37] The method according to any one of the preceding embodiments, wherein the summed amount of the one or more polymers and of the one or more reactive diluents is preferably from 10 to 60 wt. %, more preferably from 15 to 50 wt. %, more preferably from 15 to 45 wt. %, even more preferably from 20 to 40 wt. %, even more preferably from 25 to 35 wt. %, based on the entire weight of the aqueous, radiation-curable coating composition.

[38] The method according to any one of the preceding embodiments, wherein the aqueous, radiation curable coating composition comprises a photoinitiation system comprising one or more photoredox active compounds and one or more redox active compound.

[39] The method according to any embodiment [38], wherein the one or more photoredox active compounds have a peak absorbance in the wavelength range from 231 to 280 nm, preferably in the wavelength range from 241 to 280 nm, more preferably in the wavelength range from 241 to 270 nm, even more preferably in the wavelength range from 244 to 265 nm, or preferably in the wavelength range from 251 to 280 nm, more preferably in the range from 251 to 260 nm.

[40] The method according to embodiment [38], wherein the irradiating in step (3) is carried out with UV light having wavelengths essentially in the range from 244 to 265 nm and the one or more photoredox active compounds having a peak absorption in the wavelength range of from 244 to 265 nm.

[41] The method according to any one of embodiments to [40], wherein the one or more photoredox active compounds comprise at least one aryl ketone moiety, whereby the aryl group of the aryl ketone moiety is optionally substituted.

[42] The method according to any of embodiments to [41], wherein the one or more redox active compounds are selected from the group consisting of tertiary amines, thioethers, thiols and any mixture thereof; more preferably the one or more redox active compounds are aliphatic tertiary amines.

[43] The method according to any of embodiments to [42], wherein the one or more redox active compounds comprise one or more acrylate functional groups.

[44] The method according to any of embodiments to [43], wherein the one or more redox active compound is an aliphatic tertiary amine having at least one acrylate functional group, preferably two or more acrylate functional groups.

[45] The method according to any one of embodiments to [44], wherein the photoinitiation system is present in the aqueous, radiation curable coating composition in an amount of at least 5 wt. %, more preferably of at least 7.5 wt. % and even more preferably of at least 10 wt. % and preferably in an amount of at most 45 wt. %, more preferably of at most 40 wt. %, more preferably at most 35 wt. %, more preferably at most 30 wt. %, even more preferably at most 25 wt. %, whereby the amount is given relative to the radiation curable coating composition.

[46] The method according to any one of embodiments to [45], wherein the one or more photoredox active compounds are present in the aqueous, radiation curable coating composition in an amount of at least 1 wt. %, more preferably of at least 2 wt. %, even more preferably of at least 3 wt. %, even more preferably of at least 4 wt. %, even more preferably of at least 5 wt. % and in an amount of at most 15 wt. %, more preferably of at most 12 wt. %, even more preferably of at most 10 wt. %, even more preferably of at most 9 wt. %, whereby the amount is given relative to the aqueous, radiation curable coating composition.

[47] The method according to any one of embodiments to [46], wherein the one or more redox active compounds are present in the aqueous, radiation curable coating composition in an amount of at least 1 wt. %, more preferably of at least 2 wt. %, even more preferably of at least 3 wt. %, even more preferably of at least 4 wt. %, even more preferably of at least 5 wt. % and in an amount of at most 30 wt. %, more preferably at most 25 wt. %, even more preferably at most 20 wt. %, even more preferably at most 15 wt. %, whereby the amount is given relative to the aqueous, radiation curable coating composition.

[48] The method according to any one of embodiments to [47], wherein the one or more photoredox active compounds and the redox active compounds are present in the aqueous, radiation curable coating composition in such an amount that the ratio of the molar amount of the photoredox active groups to the molar amount of the redox active groups is from 1:4 to 4:1, more preferably from 1:3 to 3:1, even more preferably from 1:2 to 2:1.

[49] The method according to any one of the preceding embodiments, wherein the gloss of the surface of the cured coating measured at 60° geometry of angle is less than or equal to 52 gloss units, preferably is in the range from 1 to 50 gloss units, or from 4 to 40 gloss units, or from 4 to 30 gloss units, or from 4 to 20 gloss units, or from 4 to 10 gloss units; and/or the gloss of the surface of the cured coating measured at 85° geometry of angle is less than or equal to 60 gloss units, preferably is in the range from 1 to 60 gloss units, or from 5 to 40 gloss units, or from 5 to 30 gloss units.

[50] An aqueous, radiation curable coating composition as defined in any one of the preceding embodiments.

[51] A coated substrate, wherein the coated substrate is obtained by coating a substrate, preferably a plastic, wood or metal substrate or a substrate of a combination of any of plastic, paper and metal with the method of any of embodiments [1] to [49].

[54] The coated substrate according to embodiment [53], wherein the coated substrate is used as a floor covering or as a wall covering or in automotive interior or in furniture or in window frames or in façade panels.

The present invention is now illustrated by reference to the following examples. Unless otherwise specified, all parts, percentages and ratios are on a weight basis.

### COMPONENTS AND ABBREVIATIONS USED

IPDI=Isophorone diisocyanate available from Covestro
DMPA=Dimethylolpropionic acid available from Perstorp polyols
PPG2000=polypropylene glycol, OH-number=56 mg KOH/g available from BASF
TEA=triethylamine supplied by Arkema
DPGDA=dipropyleneglycoldiacrylate, available from Covestro
BHT=butylated hydroxyl toluene available from Brenntag
Hydrazine=Hydrazine hydrate (16%) available from Arkema
BismuthND=bismuthneodecanoate catalyst available from Reaxis
Omnirad 500=photoinitiator available from IGM Resins B.V.
BYK 346=Surfactant available from BYK
Butylglycol=solvent available from Aldrich
Tego Airex 902W=defoamer available from Evonik
BorchiGel=Rheology modifier available from Borchers
UV curable water borne resin 1: polyurethane resin dispersion (PUD) with reactive diluent (WB1)

Step 1: A 10⁰⁰ cm³ flask equipped with a thermometer and overhead stirrer was charged with components DMPA (21.6 g), PPG2000 (244.1 g), DPGDA (240.0 g), BHT (0.24 g) and IPDI (94.0 g). The reaction was heated to 50° C. Then 0.12 g of BismuthNeodecanoate was added. After the exotherm was complete the reaction was kept at 90° C. for 120 minutes. The NCO content of the resultant isocyanate-terminated prepolymer was 1.35% (theoretically 1.97%). The prepolymer was cooled down to 80° C. and TEA was added (16.3 g) and mixed for 10 minutes at 50-60° C.

Step 2: A dispersion of the resultant isocyanate-terminated prepolymer from step 1 was made by feeding 503 g of the resulting prepolymer mixture in 45 minutes to deionized water (890 g). The dispersion temperature was controlled between 25 to 30° C. Hydrazine (14.2 g) was added after the feed was completed. Dispersion WB1 was obtained.

### Comparative Water Borne Resin a (CWBA)

Example 1 was repeated except that no DPGDA was added in the synthesis of step 1.

Step 2: A dispersion of the resultant isocyanate-terminated prepolymer from step 1 was made by feeding 289 g of the resulting prepolymer mixture in 45 minutes to deionized water (492.5 g). The dispersion temperature was controlled between 25 to 30° C. Hydrazine (16.3 g) was added after the feed was completed. Dispersion CWBA was obtained.

UV Curable Water Borne Resin 2: Acrylate Functional Polyurethane Resin Dispersion with Reactive Diluent (WB2)

Step 1: A 10⁰⁰ cm³ flask equipped with a thermometer and overhead stirrer was charged with components DMPA (14.9 g), PPG2000 (129.8 g), HEA (18.7), BHT (0.34 g) and IPDI (85.3 g). The reaction was heated to 50° C. Then 0.025 g of BismuthNeodecanoate was added. After the exotherm was complete the reaction was kept at 90° C. for 120 minutes. The NCO content of the resultant isocyanate-terminated prepolymer was 3.82% (theoretically 4.31%). The prepolymer was cooled down to 80° C. and DPGDA (167.4 g) and TEA (11.2 g) were added and mixed for 10 minutes at 50-60° C.

Step 2: A dispersion of the resultant isocyanate-terminated prepolymer from step 1 was made by feeding 285 g of the resulting prepolymer mixture in 45 minutes to deionized water (500 g). The dispersion temperature was controlled between 25 to 30° C. Hydrazine (13.58 g) was added after the feed was completed. Dispersion WB2 was obtained.

UV Curable Water Borne Resin 3: Polyurethane Hybrid Resin Dispersion with Reactive Diluent (Wb3)

Step 1: A 2000 cm³ flask equipped with a thermometer and overhead stirrer was charged with components DMPA (37.4 g), PPG2000 (423.4 g) and IPDI (163.0 g). The reaction was heated to 50° C. Then 0.04 g of BismuthNeodecanoate was added. After the exotherm was complete the reaction was kept at 90° C. for 120 minutes. The NCO content of the resultant isocyanate-terminated prepolymer was 3.16% (theoretically 3.29%). The prepolymer was cooled down to 80° C. and TEA was added (28.3 g) and mixed for 10 minutes at 80° C.

Step 2: A dispersion of the resultant isocyanate-terminated prepolymer from step 1 was made by feeding 500 g of the resulting prepolymer mixture in 45 minutes to deionized water (850 g) containing 0.5 g Tegofoamex 805. The dispersion temperature was controlled between 25 to 30° C. Hydrazine (32.4 g of the 16% aqueous solution) was added after the feed was completed. The solid content of the resulting dispersion was 34.2 wt %.

Step 3: a 1000 cm³ flask 319.1 gram of the dispersion prepared in step 2 was mixed with 43.7 g of deionized water, 21.4 g MMA and 6.6 g BA under nitrogen atmosphere. After 45 minutes tBHPO (0.8 g (10% in water)) and FeEDTA (0.08 g (1% solution in water)) were added. Subsequently, a solution of iAA acid in water (1%, 8.4 g) neutralized with ammonia was slowly fed to the PU dispersion via a dropping funnel over a period of 15 minutes. The resulting polyurethane-vinyl polymer hybrid dispersion had a solid content of 34.7 wt % solids, a pH of 7.8 and a particle size of 58 nm.

Step 4:68 g of the dispersion obtained in step 3 was mixed with 60 g water and 15.8 g DPGDA. Dispersion WB3 was obtained.

UV Curable Water Borne Resin 4: Polyacrylate Resin Dispersion with Reactive Diluent (WB4)

Step 1: A 2000 cm³ flask equipped with a thermometer, N2 inlet and overhead stirrer was charged with demineralised water (656.8 g) and sodium lauryl sulphate (19.3 g of a 30 wt % solution in water). In a funnel an emulsified monomer feed was prepared by mixing demineralised water (278.1 g), sodium lauryl sulphate (28.89 g of a 30 wt % solution in water), methylmethacrylate (MMA, 539.2 g), n-butyl acrylate (n-BA, 128.1 g), acrylic acid (AA, 20.6 g) and n-dodecyl mercaptane (n-DM 13.8 g). In another funnel an initiator solution was charged by dissolving ammonium persulphate (AP, 2.3 g) in demineralised water (68.6 g) and adjusting the pH with 25% ammonia to 7.0-7.5. The reactor was heated to 65° C. and 10 wt % of the emulsified monomer feed was added to the reactor and the reaction temperature was allowed to increase to 75° C. At 75° C. a shot of ammonium persulphate (1.2 g) dissolved in demineralized water (6.0 g) was added and the exotherm was allowed to run. After mixing for 10 minutes the reactor temperature was levelled at 85° C. Next, the monomer feed and initiator feed were added over a period of 150 minutes at a temperature of 83-87° C. At the end of the monomer feed demineralised water (7.4 g) was used to rinse the funnel holding the monomer mixture. The reaction was allowed to drift for 15 minutes to 80° C. . . . Next, a solution of ammonia (25%, 4.5 g) in demineralised water (4.5 g) was added and the temperature was allowed to drift for 15 minutes. Next the batch was cooled to 30° C. and Proxel Ultra 10 (3.6 g of a 10 wt % solution) was added in 10 minutes. The pH was checked and if needed adjusted to 7.8-8.0 with ammonia (12.5%). Finally, the batch was filtered through a filter cloth to remove any coagulum formed during the reaction. The solid content was 39.6%, the particle size was 74 nm. The theoretical Tg was set at 60° C., the measured Tg (DSC) was 65.1° C. The acid value was 23.4 mg KOH/g solid.

Step 2:66.5 g of the dispersion obtained in the previous step was mixed with 20 g water and 17.6 g DPGDA. Dispersion WB4 was obtained.

### PREPARATION OF FORMULATIONS

The ingredients listed in Table 1 were added into a PE jar and mixed thoroughly using a Dispermill® (OrangeLine, ATP Engineering B.V.).

TABLE 1
Preparation of the UV curable water borne coating compositions
(Dispersions 1-4 and Comparative Dispersion A)

| | | Comp | | | |
|---|---|---|---|---|---|
| | Dispersion 1 | dispersion A | Dispersion 2 | Dispersion 3 | Dispersion 4 |
| | D1 | DA | D2 | D3 | D4 |
| Starting | WB1 | CWBA | WB2 | WB3 | WB4 |
| Dispersion | | | | | |
| Amount | 76 | 76 | 76 | 48.8 | 47 |
| Butyl glycol | 1 | 1 | 1 | 0 | 0 |
| BYK-346 | 0.5 | 0.5 | 0.5 | 0 | 0 |
| Tego airex | 0.5 | 0.5 | 0.5 | 0 | 0 |
| 902W | | | | | |
| Borchi Gel | 1 | 1 | 1 | 0 | 0 |
| 75N (50% in | | | | | |
| water) | | | | | |
| Ominrad 500 | 1 | 1 | 1 | 1.2 | 1.1 |
| Agisyn 008 | 0 | 0 | 0 | 0 | 1.9 |
| Water | 19.3 | 19.5 | 6.8 | 0 | 0 |

### Application and Drying of the Coating Compositions (Step (1) and (2))

The so-obtained coating compositions were applied on the white part of a Leneta card (2C Leneta Inc) using a 100 μm wire rod applicator. The coated cards were dried for 10 minutes in an oven with airspeed of 1.2 m/s at 50° C. Subsequently the so-obtained dried composition were cured, the cure conditions are indicated in Table 2.

### Examples 1-8 (Curing of the Coating Composition Employing a Low Pressure Mercury Vapor Lamp in the Skin-Cure Step) and Comparative Experiments CEA-CEC (See Table 2)

The so-obtained dried coating compositions were cured on a UVio curing rig with a conveyor belt equipped with multiple lamps.

The dried radiation curable coating composition was irradiated with UV light using an Heraeus BlueLight® Premium P2035 U V Disinfection System with an intensity of 65 mW/cm² (low pressure mercury vapor lamp with dominant emission peak at 254 nm (>90%), irradiance measured by UV Power Puck® ∥ 32 mW/cm²) (the skin cure step (step (3)).

Subsequently the skin cured coating composition was irradiated using a medium pressure mercury vapor lamp (Heraeus Noblelight LightHammer® 10 MARK III H bulb, 600W/in) (step (4)).

In Comparative Experiment C (CEC), the skin cure step (step (3) was performed using medium pressure mercury vapor lamp Heraeus Noblelight LightHammer® 10 MARK III H bulb, 600W/in, of which the power has been lowered such that the UV-C dose in the Comparative Experiment is the same as in the Examples 1. High gloss coating with flat coating surface (i.e. no microfold structure) was resulted from using medium pressure mercury vapor lamp H bulb emitting light of which less than 50% having a wavelength from 231 to 280 nm.

### Testing of the Cured Coating Compositions

The gloss is determined according to ISO2813 in the direction of the drawdown and is expressed in gloss units (GU). Results are presented in Table 2.

TABLE 2

| | | | Skincure | Final cure | | |
|---|---|---|---|---|---|---|
| | | | (Step (3)) | (Step (4)) | | |
| | | | Dose | Dose | | |
| | Coating | | UVA/UVB/UVC | UVA/UVB/UVC | Gloss | Gloss |
| Ex | comp | Type | mJ/cm² | mJ/cm² | 60° | 85° |
| 1 | D1 | Polyurethane | —/—/12 | 242/141/42 | 7 | 10 |
| | | dispersion | | | | |
| 2 | D1 | Polyurethane | —/—/22 | 242/141/42 | 10 | 17 |
| | | dispersion | | | | |
| 3 | D2 | Acrylated | —/—/12 | 242/141/42 | 10 | 10 |
| | | polyurethane | | | | |
| | | dispersion | | | | |
| 4 | D2 | Acrylated | —/—/22 | 242/141/42 | 25 | 19 |
| | | polyurethane | | | | |
| | | dispersion | | | | |
| 5 | D3 | Polyurethane- | —/—/12 | 242/141/42 | 4 | 9 |
| | | acrylic hybrid | | | | |
| | | dispersion | | | | |
| 6 | D3 | Polyurethane- | —/—/16 | 242/141/42 | 5 | 17 |
| | | acrylic hybrid | | | | |
| | | dispersion | | | | |
| 7 | D4 | Acrylic dispersion | —/—/7 | 242/141/42 | 6 | 4 |
| 8 | D4 | Acrylic dispersion | —/—/22 | 242/141/42 | 10 | 7 |
| CEA | DA | Non UV curable | —/—/12 | 242/141/42 | >85 | >90 |
| | | dispersion | | | | |
| CEB | DA | Non UV curable | —/—/22 | 242/141/42 | >85 | >90 |
| | | dispersion | | | | |
| CEC | D1 | Polyurethane | 34/27/12 | 242/141/42 | >85 | >90 |
| | | dispersion | | | | |

These results clearly show that reduced gloss can be obtained with the method according to the invention with a variety of UV curable waterborne resins whereas for a non UV curable waterborne resin no gloss reduction is obtained. It furthermore demonstrates that for step (3) the majority of light should be UVC.

1. A method for producing a cured coating with a low gloss surface from an aqueous, radiation curable coating composition, comprising:
(1) applying an aqueous, radiation curable coating composition on a substrate,
(2) drying the aqueous, radiation curable coating composition, affording an at least partially dried coating composition,
(3) irradiating the at least partially dried coating composition from step (2) with UV light having wavelengths essentially in the range from 231 to 280 nm, wherein UV light having wavelengths essentially in the wavelength range from 231 to 280 means that at least 60% of the actinic radiation power of the applied radiation source in step (3) is provided by UV light in the wavelength range of from 231 to 280 nm, affording a coating with a partially cured surface layer with reduced gloss,
followed by
(4) finish curing the coating from step (3) with actinic radiation, thereby fixating the partially cured surface layer with reduced gloss and affording the cured coating with the low gloss surface,
wherein step (3) and step (4) are performed in air; and
wherein the aqueous, radiation curable coating composition comprises at least one polymer, at least one reactive diluent, and water.

2. The method according to claim 1, wherein the at least one polymer is selected from the group consisting of polyurethane, radiation curable polyurethane, vinyl polymer, polyester, polyurethane-vinyl polymer hybrid, and any mixture thereof.

3. The method according to claim 1, wherein the aqueous, radiation curable coating composition is a dispersion comprising:
(A) particles comprising at least one water-dispersed polymer,
(B) at least one radiation curable diluent (B) with a molar mass less than 800 g/mol and with an acrylate functionality of from 1 to 6, and
(C) water and optionally organic solvent, wherein the optional organic solvent is present in an amount of at most 30 wt. %, based on the total weight of water and organic solvent,
wherein the amount of (A) is from 30 to 95 wt. % and the amount of (B) is from 5 to 70 wt. %, based on the total weight of (A) and (B).

4. The method according to claim 1, wherein the at least one reactive diluent has a molar mass higher than 125 g/mol and lower than 800 g/mol.

5. The method according to claim 1, wherein the at least one reactive diluent is an acrylate functional diluent with an acrylate functionality of from 1 to 6.

6. The method according to claim 1, wherein the aqueous, radiation curable coating composition comprises at least two acrylate functional diluents with different acrylate functionality, wherein the at least two acrylate functional diluents with different functionality having an average acrylate functionality of at least 1.1 and at most 3.5.

7. The method according to claim 1, wherein the amount of the at least one polymer is from 35 to 80 wt. % and the amount of the at least one reactive diluent is from 20 to 65 wt. %, based on the total weight of polymer and reactive diluent present in the aqueous, radiation curable composition.

8. The method according to claim 1, wherein the total amount of the at least one polymer and of the at least one reactive diluent is at least 10 wt. %, based on the entire weight of the aqueous, radiation-curable coating composition.

9. The method according to claim 1, wherein the amount of water is at least 5 wt. %, based on the entire weight of the aqueous, radiation curable composition.

10. The method according to claim 1, wherein the at least one reactive diluent is aliphatic.

11. The method according to claim 1, wherein the at least one polymer is aliphatic.

12. The method according to claim 1, wherein the gloss of the surface of the cured coating measured at 60° geometry of angle is less than or equal to 52 gloss units and/or the gloss of the surface of the cured coating measured at 85° geometry of angle is less than or equal to 60 gloss units.

13. The method according to claim 1, wherein the aqueous, radiation curable coating composition comprises a photo-initiating system comprising at least one absorption peak at a wavelength in the range from 231 to 280 nm.

14. The method according to claim 1, wherein UV irradiation is applied in step (4) and the aqueous, radiation curable coating composition comprises a photo-initiating system comprising at least one absorption peak at a wavelength in the range from 231 to 280 nm and at least one absorption peak at a wavelength higher than 280 nm.

15. A coated substrate obtained by the method of claim 1.

16. (canceled)

17. The method according to claim 1, wherein the aqueous, radiation curable coating composition is a dispersion comprising:
(A) particles comprising at least one water-dispersed polymer selected from the group consisting of polyurethane, radiation curable polyurethane, vinyl polymer, polyester, polyurethane-vinyl polymer hybrid, and any mixture thereof,
(B) at least one radiation curable diluent (B) with a molar mass less than 800 g/mol and with an acrylate functionality of from 1 to 6, and
(C) water and optionally organic solvent, wherein the optional organic solvent is present in an amount of at most 30 wt. %, based on the total weight of water and organic solvent,
wherein the amount of (A) is from 30 to 95 wt. % and the amount of (B) is from 5 to 70 wt. %, based on the total weight of (A) and (B).
